(19) United States
(12) Patent Application Publication
(10) Pub. No.: US 2017/0061329 A1
(43) Pub. Date: Mar. 2, 2017

(54) MACHINE LEARNING MANAGEMENT APPARATUS AND METHOD

(71) Applicant: FUJITSU LIMITED, Kawasaki-shi (JP)

(72) Inventors: Kenichi KOBAYASHI, Kawasaki (JP); Akira URA, Yokohama (JP); Haruyasu Ueda, Ichikawa (JP)

(73) Assignee: FUJITSU LIMITED, Kawasaki-shi (JP)

(21) Appl. No.: 15/224,702

(22) Filed: Aug. 1, 2016

(30) Foreign Application Priority Data
Aug. 31, 2015 (JP) 2015-170881

(51) Int. Cl. G06N 99/00; G06N 7/00

(52) U.S. Cl. CPC G06N 99/005; G06N 7/005

(57) ABSTRACT

A machine learning management device executes each of a plurality of machine learning algorithms by using training data. The machine learning management device calculates, based on execution results of the plurality of machine learning algorithms, increase rates of prediction performances of a plurality of models generated by the plurality of machine learning algorithms, respectively. The machine learning management device selects, based on the increase rates, one of the plurality of machine learning algorithms and executes the selected machine learning algorithm by using other training data.

### CROSS-REFERENCE TO RELATED APPLICATION

This application is based upon and claims the benefit of priority of the prior Japanese Patent Application No. 2015-170881, filed on Aug. 31, 2015, the entire contents of which are incorporated herein by reference.

### FIELD

The embodiments discussed herein relate to a machine learning management apparatus and a machine learning management method.

### BACKGROUND

Machine learning is performed as computer-based data analysis. In machine learning, training data indicating known cases is inputted to a computer. The computer analyzes the training data and learns a model that generalizes a relationship between a factor (which may be referred to as an explanatory variable or an independent variable) and a result (which may be referred to as an objective variable or a dependent variable as needed). By using this learned model, the computer predicts results of unknown cases. For example, the computer can learn a model that predicts a person's risk of developing a disease from training data obtained by research on lifestyle habits of a plurality of people and presence or absence of disease for each individual. For example, the computer can learn a model that predicts future commodity or service demands from training data indicating past commodity or service demands.

In machine learning, it is preferable that the accuracy of an individual learned model, namely, the capability of accurately predicting results of unknown cases (which may be referred to as a prediction performance) be high. If a larger size of training data is used in learning, a model indicating a higher prediction performance is obtained. However, if a larger size of training data is used, more time is needed to learn a model. Thus, progressive sampling has been proposed as a method for efficiently obtaining a model indicating a practically sufficient prediction performance.

With the progressive sampling, first, a computer learns a model by using a small size of training data. Next, by using test data indicating a known case different from the training data, the computer compares a result predicted by the model with the known result and evaluates the prediction performance of the learned model. If the prediction performance is not sufficient, the computer learns a model again by using a larger size of training data than the size of the last training data. The computer repeats this procedure until a sufficiently high prediction performance is obtained. In this way, the computer can avoid using an excessively large size of training data and can shorten the time needed to learn a model.

Regarding the progressive sampling, there has been proposed a method for determining whether the prediction performance has increased to be sufficiently high. In this method, when the difference between the prediction performance of the latest model and the prediction performance of the last model (the increase amount of the prediction performance) has fallen below a predetermined threshold, the prediction performance is determined to be sufficiently high. There has been proposed another method for determining whether the prediction performance has increased to be sufficiently high. In this method, when the increase amount of the prediction performance in per unit learning time has falled below a predetermined threshold, the prediction performance is determined to be sufficiently high.

In addition, there has been proposed a demand prediction system for predicting a product demand by using a neural network. This demand prediction system generates predicted demand data in a second period from sales result data in a first period by using each of a plurality of prediction models. The demand prediction system compares the predicted demand data in the second period with sales results data in the second period and selects one of the plurality of prediction models that has outputted predicted demand data that is closest to the sales results data. The demand prediction system uses the selected prediction model to predict the next product demand.

In addition, there has been proposed a distributed-water prediction apparatus for predicting a demanded water volume at waterworks facilities. This distributed-water prediction apparatus selects training data that is used in machine learning, from data indicating distributed water in the past. The distributed-water prediction apparatus predicts a demanded water volume by using the selected training data and a neural network and also predicts a demanded water volume by using the selected training data and multiple regression analysis. The distributed-water prediction apparatus integrates the result predicted by using the neural network and the result predicted by using the multiple regression analysis and outputs a predicted result indicating the integrated demanded water volume.

There has also been proposed a time-series prediction system for predicting a future power demand. This time-series prediction system calculates a plurality of predicted values by using a plurality of prediction models each having a different sensitivity with respect to a factor that magnifies an error and calculates a final predicted value by combining a plurality of predicted values. The time-series prediction system monitors a prediction error between a predicted value and a result value of each of a plurality of prediction models and changes the combination of a plurality of prediction models, depending on change of the prediction error.

See, for example, the following documents:
Japanese Laid-open Patent Publication No. 10-143490
Japanese Laid-open Patent Publication No. 2000-305606
Japanese Laid-open Patent Publication No. 2007-108809
Foster Provost, David Jensen and Tim Oates, “Efficient Progressive Sampling”, Proc. of the 5th International Conference on Knowledge Discovery and Data Mining, pp. 23-32, Association for Computing Machinery (ACM), 1999. Christopher Meek, Bo Thiesson and David Heckerman, “The Learning-Curve Sampling Method Applied to Model-Based Clustering”, Journal of Machine Learning Research, Volume 2 (February), pp. 397-418, 2002.

Various machine learning algorithms such as a regression analysis, a support vector machine (SVM), and a random forest have been proposed as procedures for learning a model from training data. If a different machine learning algorithm is used, a learned model indicates a different prediction performance. Namely, it is more likely that a prediction performance obtained by using a plurality of machine learning algorithms is better than that obtained by using only one machine learning algorithm.

However, even when the same machine learning algorithm is used, the obtained prediction performance or learning time varies depending on the training data, namely, on the nature of the content of learning. If a computer uses a certain machine learning algorithm to learn a model that predicts a commodity demand, the computer could indicate a larger amount of increase of the prediction performance with a larger size of training data. However, if the computer uses the same machine learning algorithm to learn a model that predicts the risk of developing a disease, the computer could indicate a smaller amount of increase of the prediction performance with a larger size of training data. Namely, it is difficult to previously know which one of a plurality of machine learning algorithms reaches a high prediction performance or a desired prediction performance within a short learning time.

In one machine learning method, a plurality of machine learning algorithms are executed independently of each other to acquire a plurality of models, and a model indicating the highest prediction performance is used. When a computer repeats model learning while changing training data as in the above progressive sampling, the computer may execute this repetition for each of the plurality of machine learning algorithms.

However, if a computer repeats model learning while changing training data for each of a plurality of machine learning algorithms, the computer performs a lot of unnecessary learning that does not contribute to improvement in the prediction performance of the finally used model. Namely, there is a problem that excessively long learning time is needed. In addition, the above machine learning method has a problem that a machine learning algorithm that reaches a high prediction performance cannot be determined unless all the plurality of machine learning algorithms are executed completely.

### SUMMARY

According to one aspect, there is provided a non-transitory computer-readable recording medium storing a computer program that causes a computer to perform a procedure including: executing each of a plurality of machine learning algorithms by using training data; calculating, based on execution results of the plurality of machine learning algorithms, increase rates of prediction performances of a plurality of models generated by the plurality of machine learning algorithms, respectively; and selecting, based on the increase rates, one of the plurality of machine learning algorithms and executing the selected machine learning algorithm by using other training data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a machine learning management device according to a first embodiment;

FIG. 2 is a block diagram of a hardware example of a machine learning device;

FIG. 3 is a graph illustrating an example of a relationship between the sample size and the prediction performance;

FIG. 4 is a graph illustrating an example of a relationship between the learning time and the prediction performance;

FIG. 5 illustrates a first example of how a plurality of machine learning algorithms are used;

FIG. 6 illustrates a second example of how the plurality of machine learning algorithms are used;

FIG. 7 illustrates a third example of how the plurality of machine learning algorithms are used;

FIG. 8 is a block diagram illustrating an example of functions of a machine learning device according to a second embodiment;

FIG. 9 illustrates an example of a management table;

FIGS. 10 and 11 are flowcharts illustrating an example of a procedure of machine learning according to the second embodiment;

FIG. 12 is a flowchart illustrating an example of a procedure of execution of a learning step according to the second embodiment;

FIG. 13 is a flowchart illustrating an example of a procedure of execution of time estimation;

FIG. 14 is a flowchart illustrating an example of a procedure of estimation of a performance improvement amount;

FIG. 15 is a block diagram illustrating an example of functions of a machine learning device according to a third embodiment;

FIG. 16 illustrates an example of an estimation expression table;

FIG. 17 is a flowchart illustrating an example of another procedure of execution of time estimation;

FIG. 18 is a block diagram illustrating an example of functions of a machine learning device according to a fourth embodiment;

FIG. 19 is a flowchart illustrating an example of a procedure of execution of a learning step according to the fourth embodiment;

FIG. 20 illustrates an example of hyperparameter vector space;

FIG. 21 is a first example of how a set of hyperparameter vectors is divided;

FIG. 22 is a second example of how a set of hyperparameter vectors is divided;

FIG. 23 is a block diagram illustrating an example of functions of a machine learning device according to a fifth embodiment; and

FIGS. 24 and 25 are flowcharts illustrating an example of a procedure of machine learning according to the fifth embodiment.

### DESCRIPTION OF EMBODIMENTS

Several embodiments will be described below with reference to the accompanying drawings, wherein like reference characters refer to like elements throughout.

### First Embodiment

A first embodiment will be described.

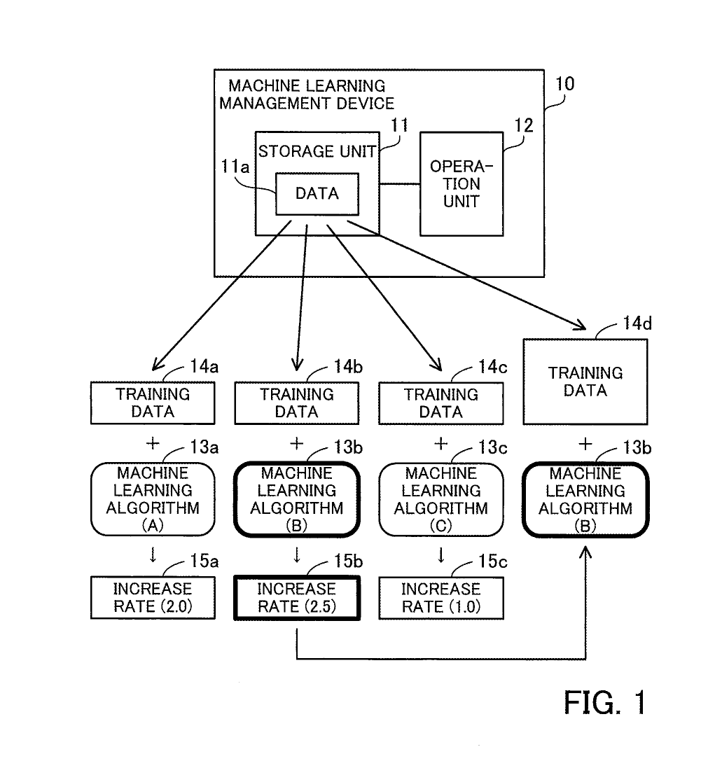

FIG. 1 illustrates a machine learning management device 10 according to the first embodiment.

The machine learning management device 10 according to the first embodiment generates a model that predicts results of unknown cases by performing machine learning using known cases. The machine learning performed by the machine learning management device 10 is applicable to various purposes, such as for predicting the risk of developing a disease, predicting future commodity or service demands, and predicting the yield of new products at a factory. The machine learning management device 10 may be a client computer operated by a user or a server computer accessed by a client computer via a network, for example.

The machine learning management device 10 includes a storage unit 11 and an operation unit 12. The storage unit 11 may be a volatile semiconductor memory such as a random access memory (RAM) or a non-volatile storage such as a hard disk drive (HDD) or a flash memory. For example, the operation unit 12 is a processor such as a central processing unit (CPU) or a digital signal processor (DSP). The operation unit 12 may include an electronic circuit for specific use such as an application specific integrated circuit (ASIC) or a field programmable gate array (FPGA). The processor executes programs held in a memory such as a RAM (the storage unit 11, for example). The programs include a machine learning management program. A group of processors (multiprocessor) may be referred to as a “processor.”

The storage unit 11 holds data 11a used for machine learning. The data 11a indicates known cases. The data 11a may be collected from the real world by using a device such as a sensor or may be created by a user. The data 11a includes a plurality of unit data (which may be referred to as records or entries). A single unit data indicates a single case and includes, for example, a value of at least one variable (which may be referred to as an explanatory variable or an independent variable) indicating a factor and a value of a variable (which may be referred to as an objective variable or a dependent variable) indicating a result.

The operation unit 12 is able to execute a plurality of machine learning algorithms. For example, the operation unit 12 is able to execute various machine learning algorithms such as a logistic regression analysis, a support vector machine, and a random forest. The operation unit 12 may execute a few dozen to hundreds of machine learning algorithms. However, for ease of the description, the first embodiment will be described assuming that the operation unit 12 executes three machine learning algorithms A to C.

In addition, herein, the operation unit 12 repeatedly executes an individual machine learning algorithm while changing training data used in model learning. For example, the operation unit 12 uses progressive sampling in which the operation unit 12 repeatedly executes an individual machine learning algorithm while increasing the size of the training data. With the progressive sampling, it is possible to avoid using an excessively large size of training data and learn a model having a desired prediction performance within a short time. When the operation unit 12 uses a plurality of machine learning algorithms and repeatedly executes an individual machine learning algorithm while changing the training data, the operation unit 12 proceeds with the machine learning as follows.

First, the operation unit 12 executes each of a plurality of machine learning algorithms by using some of the data 11a held in the storage unit 11 as the training data and generates a model for each of the machine learning algorithms. For example, an individual model is a function that acquires a value of at least one variable indicating a factor as an argument and that outputs a value of a variable indicating a result (a predicted value indicating a result). By the machine learning, a weight (coefficient) of each variable indicating a factor is determined.

For example, the operation unit 12 executes a machine learning algorithm 13a (the machine learning algorithm A) by using training data 14a extracted from the data 11a. In addition, the operation unit 12 executes a machine learning algorithm 13b (the machine learning algorithm B) by using training data 14b extracted from the data 11a. In addition, the operation unit 12 executes a machine learning algorithm 13c (the machine learning algorithm C) by using training data 14c extracted from the data 11a. Each of the training data 14a to 14c may be the same set of unit data or a different set of unit data. In the latter case, each of the training data 14a to 14c may be randomly sampled from the data 11a.

After the operation unit 12 executes each of the plurality of machine learning algorithms, the operation unit 12 refers to each of the execution results and calculates the increase rate of the prediction performance of a model obtained per machine learning algorithm. The prediction performance of an individual model indicates the accuracy thereof, namely, indicates the capability of accurately predicting results of unknown cases. As an index representing the prediction performance, for example, the accuracy, precision, or root mean squared error (RMSE) may be used. The operation unit 12 calculates the prediction performance by using test data that is included in the data 11a and that is different from the training data. The test data may be randomly sampled from the data 11a. By comparing a result predicted by a model with a corresponding known result, the operation unit 12 calculates the prediction performance of the model. For example, the size of the test data may be about half of the size of the training data.

The increase rate indicates the increase amount of the prediction performance per unit learning time, for example. For example, the learning time that is needed when the training data is changed next can be estimated from the results of the learning times obtained up until now. For example, the increase amount of the prediction performance that is obtained when the training data is changed next can be estimated from the results of the prediction performances of the models generated up until now.

For example, the operation unit 12 calculates an increase rate 15a of the machine learning algorithm 13a from the execution result of the machine learning algorithm 13a. In addition, the operation unit 12 calculates an increase rate 15b of the machine learning algorithm 13b from the execution result of the machine learning algorithm 13b. In addition, the operation unit 12 calculates an increase rate 15c of the machine learning algorithm 13c from the execution result of the machine learning algorithm 13c. Assuming that the operation unit 12 has calculated that the increase rates 15a to 15c are 2.0, 2.5, and 1.0, respectively, the increase rate 15b of the machine learning algorithm 13b is the highest.

After calculating the increase rates of the respective machine learning algorithms, the operation unit 12 selects one of the machine learning algorithms on the basis of the increase rates. For example, the operation unit 12 selects a machine learning algorithm indicating the highest increase rate. In addition, the operation unit 12 executes the selected machine learning algorithm by using some of the data 11a held in the storage unit 11 as the training data. It is preferable that the size of the training data used next be larger than that of the training data used last. The size of the training data used next may include some or all of the training data used last.

For example, the operation unit 12 determines that the increase rate 15b is the highest among the increase rates 15a to 15c and selects the machine learning algorithm 13b indicating the increase rate 15b. Next, by using training data 14d extracted from the data 11a, the operation unit 12 executes the machine learning algorithm 13b. The training data 14d is at least a data set different from the training data 14b used last by the machine learning algorithm 13b. For example, the size of the training data 14d is about twice to four times the training data 14b.

After executing the machine learning algorithm 13b by using the training data 14d, the operation unit 12 may update the increase rate on the basis of the execution result. Next, on the basis of the updated increase rate, the operation unit 12 may select a machine learning algorithm that is executed next from the machine learning algorithms 13a to 13c. The operation unit 12 may repeat the processing for selecting a machine learning algorithm on the basis of the increase rates until the prediction performance of a generated model satisfies a predetermined condition. In this operation, one or more of the machine learning algorithms 13a to 13c may not be executed after executed for the first time.

The machine learning management device 10 according to the first embodiment executes each of a plurality of machine learning algorithms by using training data and calculates the increase rates of the prediction performances of the machine learning algorithms on the basis of the execution results, respectively. Next, on the basis of the calculated increase rates, the machine learning management device 10 selects a machine learning algorithm that is executed next by using different training data.

In this way, the machine learning management device 10 learns a model indicating higher prediction performance, compared with a case in which only one machine learning algorithm is used. In addition, compared with a case in which the machine learning management device 10 repeatedly executes all the machine learning algorithms while changing training data, the machine learning management device 10 performs less unnecessary learning that does not contribute to improvement in the prediction performance of the finally used model and needs less learning time in total. In addition, even if the allowable learning time is limited, by preferentially selecting a machine learning algorithm indicating the highest increase rate, the machine learning management device 10 is able to perform the best machine learning under the limitation. In addition, even if the user stops the machine learning before its completion, the model obtained by then is the best model obtainable within the time limit. In this way, the prediction performance of a model obtained by machine learning is efficiently improved.

### Second Embodiment

Next, a second embodiment will be described.

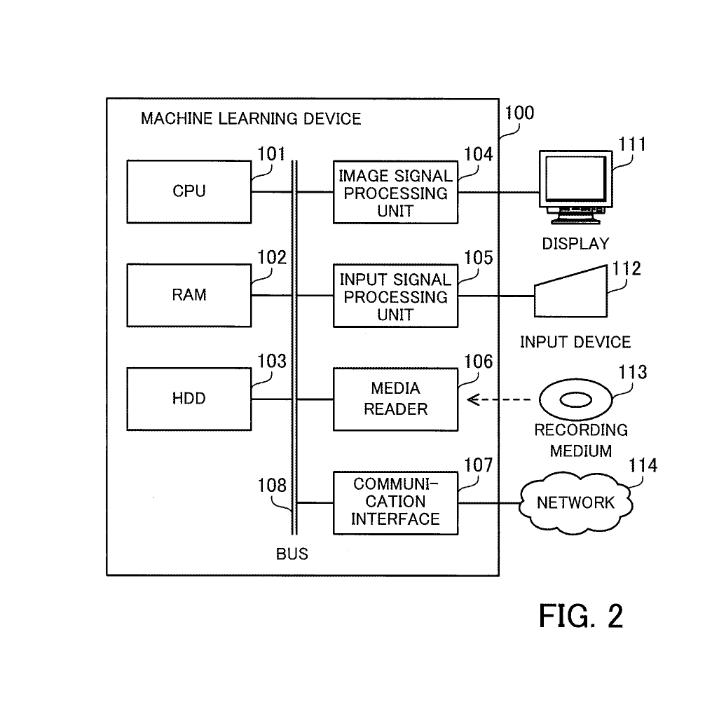

FIG. 2 is a block diagram of a hardware example of a machine learning device 100.

The machine learning device 100 includes a CPU 101, a RAM 102, an HDD 103, an image signal processing unit 104, an input signal processing unit 105, a media reader 106, and a communication interface 107. The CPU 101, the RAM 102, the HDD 103, the image signal processing unit 104, the input signal processing unit 105, the media reader 106, and the communication interface 107 are connected to a bus 108. The machine learning device 100 corresponds to the machine learning management device 10 according to the first embodiment. The CPU 101 corresponds to the operation unit 12 according to the first embodiment. The RAM 102 or the HDD 103 corresponds to the storage unit 11 according to the first embodiment.

The CPU 101 is a processor which includes an arithmetic circuit that executes program instructions. The CPU 101 loads at least a part of programs or data held in the HDD 103 to the RAM 102 and executes the program. The CPU 101 may include a plurality of processor cores, and the machine learning device 100 may include a plurality of processors. The processing described below may be executed in parallel by using a plurality of processors or processor cores. In addition, a group of processors (multiprocessor) may be referred to as a “processor.”

The RAM 102 is a volatile semiconductor memory that temporarily holds a program executed by the CPU 101 or data used by the CPU 101 for calculation. The machine learning device 100 may include a different kind of memory other than the RAM. The machine learning device 100 may include a plurality of memories.

The HDD 103 is a non-volatile storage device that holds software programs and data such as an operating system (OS), middleware, or application software. The programs include a machine learning management program. The machine learning device 100 may include a different kind of storage device such as a flash memory or a solid state drive (SSD). The machine learning device 100 may include a plurality of non-volatile storage devices.

The image signal processing unit 104 outputs an image to a display 111 connected to the machine learning device 100 in accordance with instructions from the CPU 101. Examples of the display 111 include a cathode ray tube (CRT) display, a liquid crystal display (LCD), a plasma display panel (PDP), and an organic electro-luminescence (OEL) display.

The input signal processing unit 105 acquires an input signal from an input device 112 connected to the machine learning device 100 and outputs the input signal to the CPU 101. Examples of the input device 112 include a pointing device such as a mouse, a touch panel, a touch pad, or a trackball, a keyboard, a remote controller, and a button switch. A plurality of kinds of input device may be connected to the machine learning device 100.

The media reader 106 is a reading device that reads programs or data recorded in a recording medium 113. Examples of the recording medium 113 include a magnetic disk such as a flexible disk (FD) or an HDD, an optical disc such as a compact disc (CD) or a digital versatile disc (DVD), a magneto-optical disk (MO), and a semiconductor memory. For example, the media reader 106 stores a program or data read from the recording medium 113 in the RAM 102 or the HDD 103.

The communication interface 107 is an interface that is connected to a network 114 and that communicates with other information processing devices via the network 114. The communication interface 107 may be a wired communication interface connected to a communication device such as a switch via a cable or may be a wireless communication interface connected to a base station via a wireless link.

The media reader 106 may not be included in the machine learning device 100. The image signal processing unit 104 and the input signal processing unit 105 may not be included in the machine learning device 100 if a terminal device operated by a user can control the machine learning device 100. The display 111 or the input device 112 may be incorporated in the enclosure of the machine learning device 100.

Next, a relationship among the sample size, the prediction performance, and the learning time in machine learning and progressive sampling will be described.

In the machine learning according to the second embodiment, data including a plurality of unit data indicating known cases is collected in advance. The machine learning device 100 or a different information processing device may collect the data from various kinds of device such as a sensor device via the network 114. The collected data may be a large size of data called “big data.” Normally, each unit data includes at least two values of explanatory variables and a value of an objective variable. For example, in machine learning for predicting a commodity demand, result data including factors that affect the product demand such as the temperature and the humidity as the explanatory variables and a product demand as the objective variable is collected.

The machine learning device 100 samples some of the unit data in the collected data as training data and learns a model by using the training data. The model indicates a relationship between the explanatory variables and the objective variable and normally includes at least two explanatory variables, at least two coefficients, and one objective variable. For example, the model may be represented by any one of various kinds of expression such as a linear expression, a polynomial of degree 2 or more, an exponential function, or a logarithmic function. The form of the mathematical expression may be specified by the user before machine learning. The coefficients are determined on the basis of the training data by the machine learning.

By using a learned model, the machine learning device 100 predicts a value (result) of the objective variable of an unknown case from the values (factors) of the explanatory variables of unknown cases. For example, the machine learning device 100 predicts a product demand in the next term from the weather forecast in the next term. The result predicted by a model may be a continuous value such as a probability value expressed by 0 to 1 or a discrete value such as a binary value expressed by YES or NO.

The machine learning device 100 calculates the “prediction performance” of a learned model. The prediction performance is the capability of accurately predicting results of unknown cases and may be referred to as “accuracy.” The machine learning device 100 samples unit data other than the training data from the collected data as test data and calculates the prediction performance by using the test data. The size of the test data is about half the size of the training data, for example. The machine learning device 100 inputs the values of the explanatory variables included in the test data to a model and compares the value (predicted value) of the objective variable that the model outputs with the value (result value) of the objective variable included in the test data. Hereinafter, evaluating the prediction performance of a learned model may be referred to as “validation.”

The accuracy, precision, RMSE, or the like may be used as the index representing the prediction performance. The following exemplary case will be described assuming that the result is represented by a binary value expressed by YES or NO. In addition, the following description assumes that, among the cases represented by N test data, the number of cases in which the predicted value is YES and the result value is YES is Tp and the number of cases in which the predicted value is YES and the result value is NO is Fp. In addition, the number of cases in which the predicted value is NO and the result value is YES is Fn, and the number of cases in which the predicted value is NO and the result value is NO is Tn. In this case, the accuracy is represented by the percentage of accurate prediction and is calculated by (Tp+Tn)/N. The precision is represented by the probability of predicting “YES” and is calculated by Tp/(Tp+Fp). The RMSE is calculated by (sum(y−ŷ)²/N)^{1/2} if the result value and the predicted value of an individual case are represented by y and ŷ, respectively.

When a single machine learning algorithm is used, if more unit data (a larger sample size) is sampled as the training data, a better prediction performance can be typically obtained.

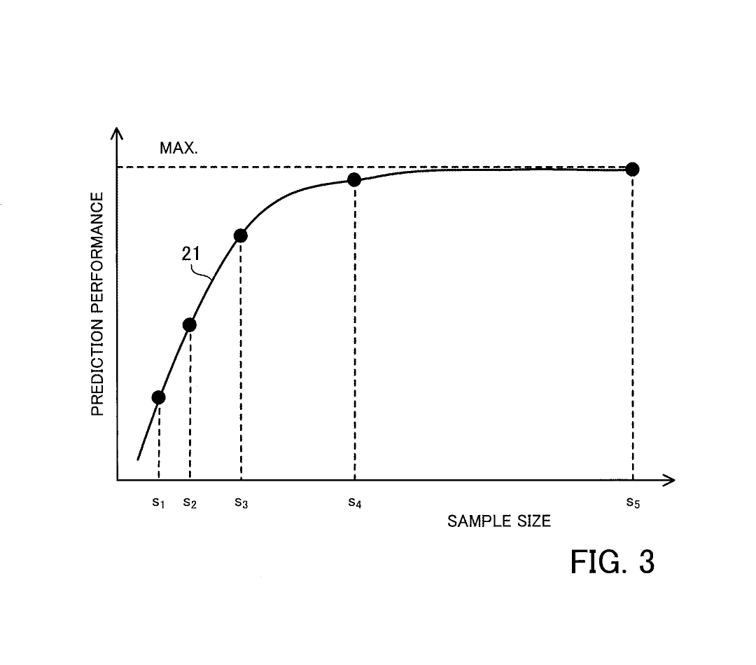

FIG. 3 is a graph illustrating an example of a relationship between the sample size and the prediction performance.

A curve 21 illustrates a relationship between the prediction performance and the sample size when a model is generated. The size relationship among the sample sizes s₁ to s₅ is s₁<s₂<s₃<s₄<s₅. For example, s₂ is twice or four times s₁, and s₃ is twice or four times s₂. In addition, s₄ is twice or four times s₃, and s₅ is twice or four times s₄.

As illustrated by the curve 21, the prediction performance obtained when the sample size is s₂ is higher than that obtained when the sample size is s₁. The prediction performance obtained when the sample size is s₃ is higher than that obtained when the sample size is s₂. The prediction performance obtained when the sample size is s₄ is higher than that obtained when the sample size is s₃. The prediction performance obtained when the sample size is s₅ is higher than that obtained when the sample size is s₄. Namely, if a larger sample size is used, a higher prediction performance is typically obtained. As illustrated by the curve 21, while the prediction performance is low, the prediction performance largely increases as the sample size increases. However, there is a maximum level for the prediction performance, and as the prediction performance comes close to its maximum level, the ratio of the increase amount of the prediction performance with respect to the increase amount of the sample size is gradually decreased.

In addition, if a larger sample size is used, more learning time is needed for machine learning. Thus, if the sample size is excessively increased, the machine learning will be ineffective in terms of the learning time. In the case in FIG. 3, if the sample size s₄ is used, the prediction performance that is close to its maximum level can be achieved within a short time. However, if the sample size s₃ is used, the prediction performance could be insufficient. While the prediction performance that is close to its maximum level can be obtained if the sample size s₅ is used, since the increase amount of the prediction performance per unit learning time is small, the machine learning will be ineffective.

This relationship between the sample size and the prediction performance varies depending on the nature of the data (the kind of the data) used, even when the same machine learning algorithm is used. Thus, it is difficult to previously estimate the minimum sample size with which the maximum prediction performance or a prediction performance close thereto can be achieved before performing machine learning. Thus, a machine learning method referred to as progressive sampling has been proposed. For example, the above document (“Efficient Progressive Sampling”) discusses progressive sampling.

In progressive sampling, a small sample size is used at first, and the sample size is gradually increased. In addition, machine learning is repeatedly performed until the prediction performance satisfies a predetermined condition. For example, the machine learning device 100 performs machine learning by using the sample size s₁ and evaluates the prediction performance of the learned model. If the prediction performance is insufficient, the machine learning device 100 performs machine learning by using the sample size s₂ and evaluates the prediction performance of the learned model. The training data of the sample size s₂ may partially or entirely include the training data having the sample size s₁ (the previously used training data). Likewise, the machine learning device 100 performs machine learning by using the sample sizes s₃ and s₄ and evaluates the prediction performances of the learned models, respectively. When the machine learning device 100 obtains a sufficient prediction performance by using the sample size s₄, the machine learning device 100 stops the machine learning and uses the model learned by using the sample size s₄. In this case, the machine learning device 100 does not need to perform machine learning by using the sample size s₅.

Various conditions may be used for stopping of the ongoing progressive sampling. For example, when the difference (the increase amount) between the prediction performance of the last model and the prediction performance of the current model falls below a threshold, the machine learning device 100 may stop the machine learning. For example, when the increase amount of the prediction performance per unit learning time falls below a threshold, the machine learning device 100 may stop the machine learning. For example, the above document (“Efficient Progressive Sampling”) discusses the former case. For example, the above document (“The Learning-Curve Sampling Method Applied to Model-Based Clustering”) discusses the latter case.

As described above, in progressive sampling, every time a single sample size (a single learning step) is processed, a model is learned and the prediction performance thereof is evaluated. Examples of the validation method in each learning step include cross validation and random sub-sampling validation.

In cross validation, the machine learning device 100 divides the sampled data into K blocks (K is an integer of 2 or more). The machine learning device 100 uses (K−1) blocks as the training data and 1 block as the test data. The machine learning device 100 repeatedly performs model learning and evaluating the prediction performance K times while changing the block used as the test data. As a result of a single learning step, for example, the machine learning device 100 outputs a model indicating the highest prediction performance among the K models and an average value of the K prediction performances. With the cross validation, the prediction performance can be evaluated by using a limited amount of data.

In random sub-sampling validation, the machine learning device 100 randomly samples training data and test data from the data population, learns a model by using the training data, and calculates the prediction performance of the model by using the test data. The machine learning device 100 repeatedly performs sampling, model learning, and evaluating the prediction performance K times.

Each sampling operation is a sampling operation without replacement. Namely, in a single sampling operation, the same unit data is not included in the training data redundantly, and the same unit data is not included in the test data redundantly. In addition, in a single sampling operation, the same unit data is not included in the training data and the test data redundantly. However, in the K sampling operations, the same unit data may be selected. As a result of a single learning step, for example, the machine learning device 100 outputs a model indicating the highest prediction performance among the K models and an average value of the K prediction performances.

There are various procedures (machine learning algorithms) for learning a model from training data. The machine learning device 100 is able to use a plurality of machine learning algorithms. The machine learning device 100 may use a few dozen to hundreds of machine learning algorithms. Examples of the machine learning algorithms include a logistic regression analysis, a support vector machine, and a random forest.

The logistic regression analysis is a regression analysis in which a value of an objective variable y and values of explanatory variables x₁, x₂, . . . , xₖ are fitted with an S-shaped curve. The objective variable y and the explanatory variables x₁ to xₖ are assumed to satisfy the relationship log(y/(1−y))=a₁x₁+a₂x₂+ . . . +aₖxₖ+b where a₁, a₂, . . . , aₖ, and b are coefficients determined by the regression analysis.

The support vector machine is a machine learning algorithm that calculates a boundary that divides a set of unit data in an N dimensional space into two classes in the clearest way. The boundary is calculated in such a manner that the maximum distance (margin) is obtained between the classes.

The random forest is a machine learning algorithm that generates a model for appropriately classifying a plurality of unit data. In the random forest, the machine learning device 100 randomly samples unit data from the data population. The machine learning device 100 randomly selects a part of the explanatory variables and classifies the sampled unit data according to a value of the selected explanatory variable. By repeating selection of an explanatory variable and classification of the unit data, the machine learning device 100 generates a hierarchical decision tree based on the values of a plurality of explanatory variables. By repeating sampling of the unit data and generation of the decision tree, the machine learning device 100 acquires a plurality of decision trees. In addition, by synthesizing these decision trees, the machine learning device 100 generates a final model for classifying the unit data.

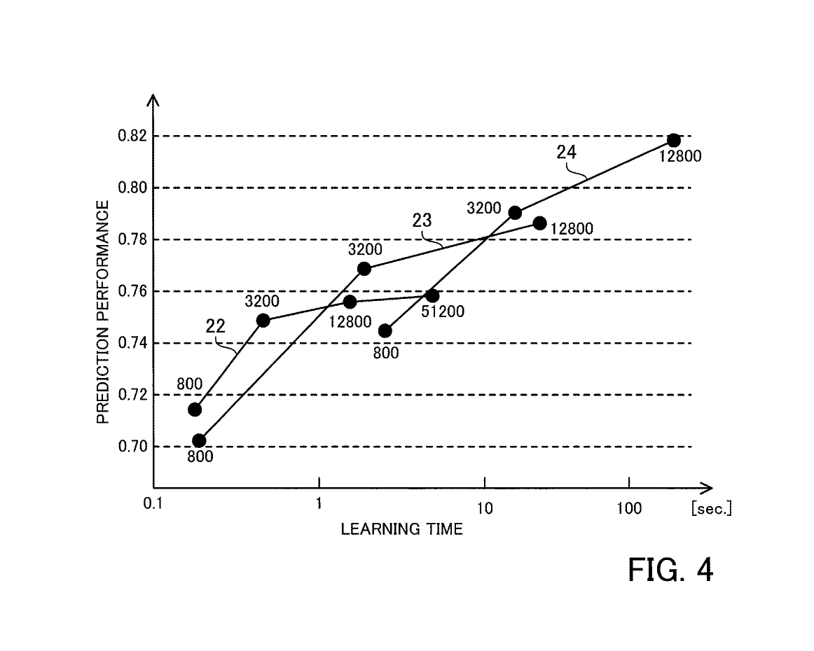

FIG. 4 is a graph illustrating an example of a relationship between the learning time and the prediction performance.

Curves 22 to 24 illustrate a relationship between the learning time and the prediction performance measured by using a noted data set (CoverType). As the index representing the prediction performance, the accuracy is used in this example. The curve 22 illustrates a relationship between the learning time and the prediction performance when a logistic regression is used as the machine learning algorithm. The curve 23 illustrates a relationship between the learning time and the prediction performance when a support vector machine is used as the machine learning algorithm. The curve 24 illustrates a relationship between the learning time and the prediction performance when a random forest is used as the machine learning algorithm. The horizontal axis in FIG. 4 represents the learning time on a logarithmic scale.

As illustrated by the curve 22 obtained by using the logistic regression, when the sample size is 800, the prediction performance is about 0.71, and the learning time is about 0.2 seconds. When the sample size is 3200, the prediction performance is about 0.75, and the learning time is about 0.5 seconds. When the sample size is 12800, the prediction performance is about 0.755, and the learning time is 1.5 seconds. When the sample size is 51200, the prediction performance is about 0.76, and the learning time is about 6 seconds.

As illustrated by the curve 23 obtained by using the support vector machine, when the sample size is 800, the prediction performance is about 0.70, and the learning time is about 0.2 seconds. When the sample size is 3200, the prediction performance is about 0.77, and the learning time is about 2 seconds. When the sample size is 12800, the prediction performance is about 0.785, and the learning time is about 20 seconds.

As illustrated by the curve 24 obtained by using the random forest, when the sample size is 800, the prediction performance is about 0.74, and the learning time is about 2.5 seconds. When the sample size is 3200, the prediction performance is about 0.79, and the learning time is about 15 seconds. When the sample size is 12800, the prediction performance is about 0.82, and the learning time is about 200 seconds.

As is clear from the curve 22, when the logistic regression is used on the above data set, the learning time is relatively short and the prediction performance is relatively low. When the support vector machine is used, the learning time is longer and the prediction performance is higher than those obtained when the logistic regression is used. When the random forest is used, the learning time is longer and the prediction performance is higher than those obtained when the support vector machine is used. However, in the case of FIG. 4, when the sample size is small, the prediction performance obtained when the support vector machine is used is lower than the prediction performance obtained when the logistic regression is used. Namely, even when progressive sampling is used, the increase curve of the prediction performance at the initial stage varies depending on the machine learning algorithm.

In addition, as described above, the maximum level or the increase curve of the prediction performance of an individual machine learning algorithm also depends on the nature of the data used. Thus, among a plurality of machine learning algorithms, it is difficult to previously determine a machine learning algorithm that can achieve the highest or nearly the highest prediction performance within the shortest time. Hereinafter, a method for efficiently obtaining a model indicating a high prediction performance by using a plurality of machine learning algorithms and progressive sampling will be described.

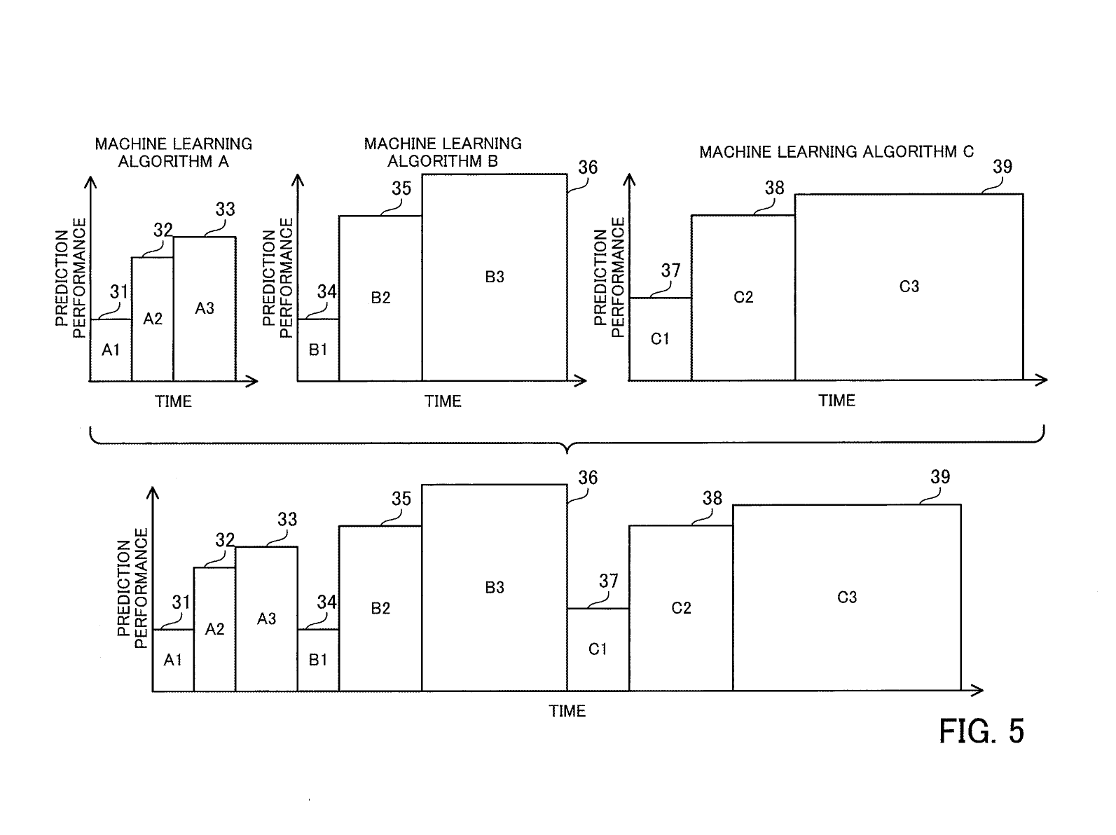

FIG. 5 illustrates a first example of how a plurality of machine learning algorithms are used.

For ease of the description, the following description will be made assuming that three machine learning algorithms A to C are used. When performing progressive sampling by using only the machine learning algorithm A, the machine learning device 100 executes learning steps 31 to 33 (A1 to A3) in this order. When performing progressive sampling by using only the machine learning algorithm B, the machine learning device 100 executes learning steps 34 to 36 (B1 to B3) in this order. When performing progressive sampling by using only the machine learning algorithm C, the machine learning device 100 executes learning steps 37 to 39 (C1 to C3) in this order. This example assumes that the respective stopping conditions are satisfied when the learning steps 33, 36, and 39 are executed.

The same sample size is used in the learning steps 31, 34, and 37. For example, the number of unit data is 10,000 in the learning steps 31, 34, and 37. The same sample size is used in the learning steps 32, 35, and 38, and the sample size used in the learning steps 32, 35, and 38, is about twice or four times of the sample size used in the learning steps 31, 34, and 37. For example, the number of unit data in the learning steps 32, 35, and 38 is 40,000. The same sample size is used in the learning steps 33, 36, and 39, and the sample size used in the learning steps 33, 36, and 39 is about twice or four times of the sample size used in the learning steps 32, 35, and 38. For example, the number of unit data used in the learning steps 33, 36, and 39 is 160,000.

The machine learning algorithms A to C and progressive sampling may be combined in accordance with the following first method. In accordance with the first method, the machine learning algorithms A to C are executed individually. First, the machine learning device 100 executes the learning steps 31 to 33 of the machine learning algorithm A. Next, the machine learning device 100 executes the learning steps 34 to 36 of the machine learning algorithm B. Finally, the machine learning device 100 executes the learning steps 37 to 39 of the machine learning algorithm C. Next, the machine learning device 100 selects a model indicating the highest prediction performance from all the models outputted by the learning steps 31 to 39.

However, in accordance with the first method, the machine learning device 100 performs many unnecessary learning steps that do not contribute to improvement in the prediction performance of the finally used model. Thus, there is a problem that the overall learning time is prolonged. In addition, in accordance with the first method, a machine learning algorithm that achieves the highest prediction performance is not determined unless all the machine learning algorithms A to C are executed. There are cases in which the learning time is limited and the machine learning is stopped before its completion. In such cases, there is no guarantee that a model obtained when the machine learning is stopped is the best model obtainable within the time limit.

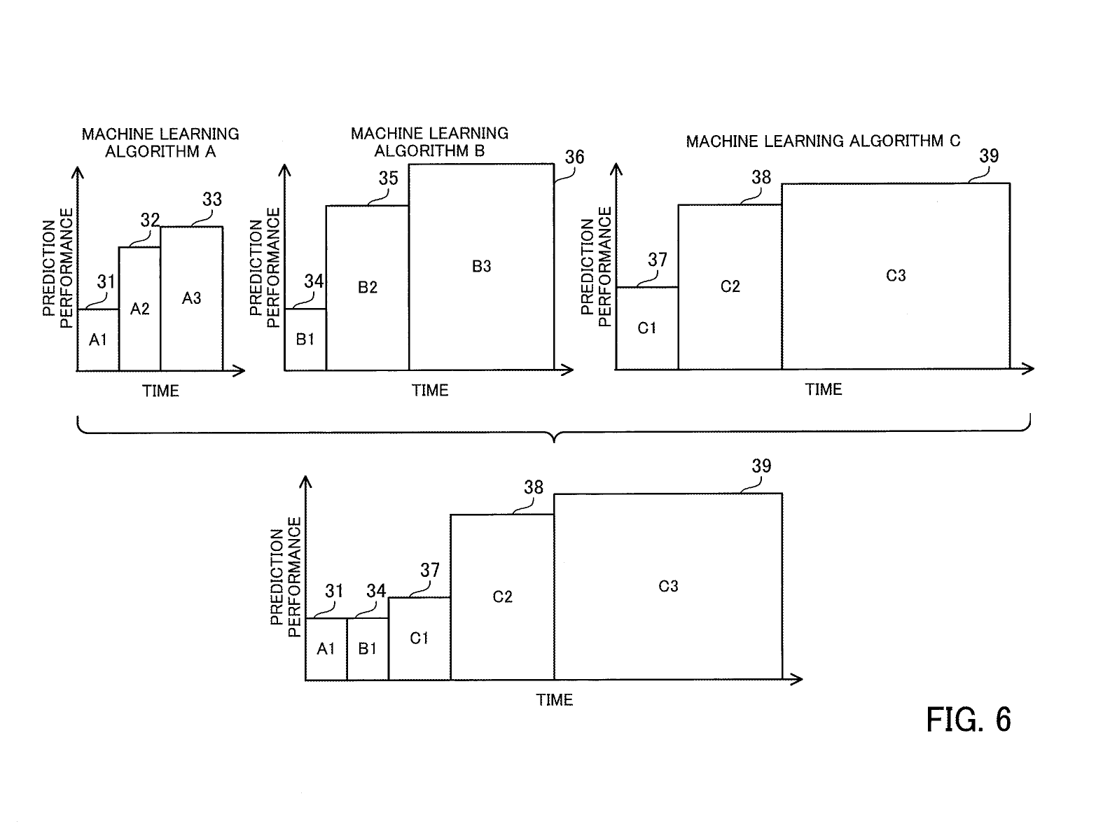

FIG. 6 illustrates a second example of how the plurality of machine learning algorithms are used.

The machine learning algorithms A to C and progressive sampling may be combined in accordance with the following second method. In accordance with the second method, first, the machine learning device 100 executes the first learning steps of the respective machine learning algorithms A to C and selects a machine learning algorithm that indicates the highest prediction performance in the first learning steps. Subsequently, the machine learning device 100 executes only the selected machine learning algorithm.

The machine learning device 100 executes the learning step 31 of the machine learning algorithm A, the learning step 34 of the machine learning algorithm B, and the learning step 37 of the machine learning algorithm C. The machine learning device 100 determines which one of the prediction performances calculated in the learning steps 31, 34, and 37 is the highest. Since the prediction performance calculated in the learning step 37 is the highest, the machine learning device 100 selects the machine learning algorithm C. The machine learning device 100 executes the learning steps 38 and 39 of the selected machine learning algorithm C. The machine learning device 100 does not execute the learning steps 32, 33, 35, and 36 of the machine learning algorithms A and B that are not selected.

However, as described with reference to FIG. 4, the level of the prediction performance obtained when the sample size is small and the level of the prediction performance obtained when the sample size is large may not be the same among a plurality of machine learning algorithms. Thus, the second method has a problem that the selected machine learning algorithm may not be the one that achieves the best prediction performance.

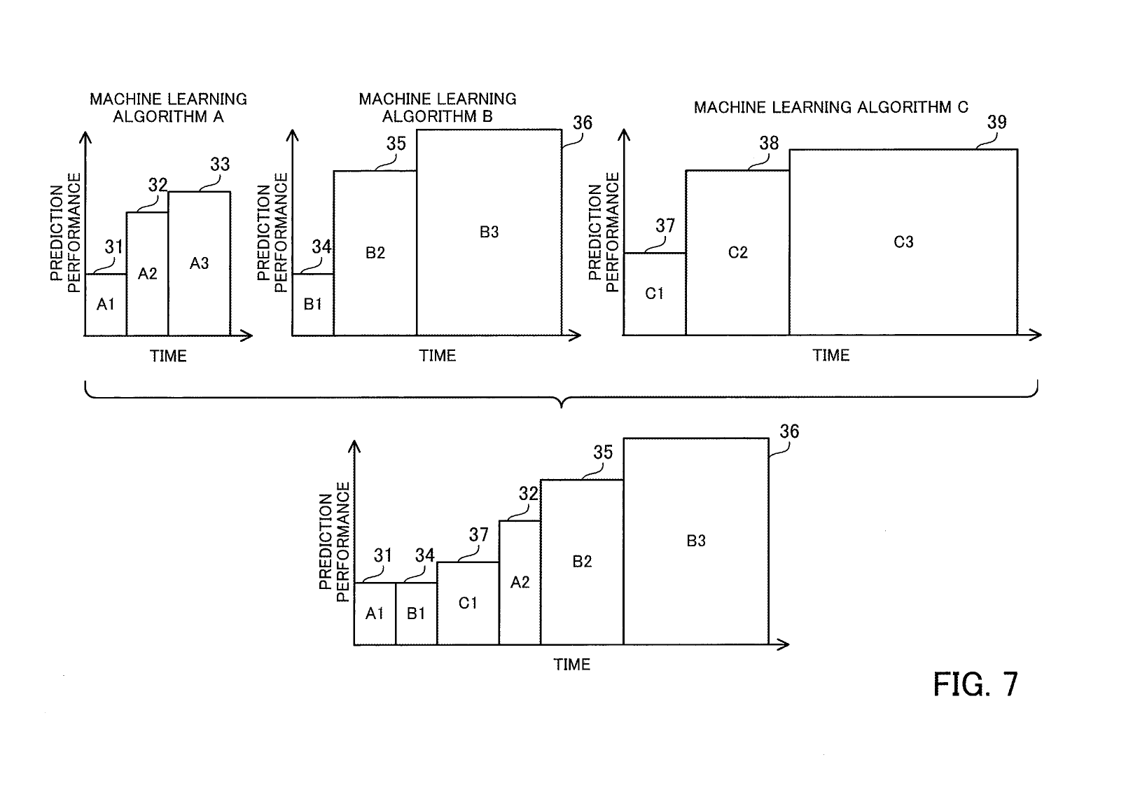

FIG. 7 illustrates a third example of how the plurality of machine learning algorithms are used.

The machine learning algorithms A to C and progressive sampling may be combined in accordance with the following third method. In accordance with the third method, per machine learning algorithm, the machine learning device 100 estimates the improvement rate of the prediction performance of a model learned by a learning step using the sample size of the next level. Next, the machine learning device 100 selects a machine learning algorithm that indicates the highest improvement rate and advances one learning step. Every time the machine learning device 100 advances the learning step, the estimated values of the improvement rates are reviewed. Thus, in accordance with the third method, while the learning steps of a plurality of machine learning algorithms are executed at first, the number of the machine learning algorithms executed is gradually decreased.

The estimated improvement rate is obtained by dividing the estimated performance improvement amount by the estimated execution time. The estimated performance improvement amount is the difference between the estimated prediction performance in the next learning step and the maximal prediction performance achieved up until now through a plurality of machine learning algorithms (which may hereinafter be referred to as an achieved prediction performance). The prediction performance in the next learning step is estimated based on a past prediction performance of the same machine learning algorithm and the sample size used in the next learning step. The estimated execution time represents the time needed for the next learning step and is estimated based on a past execution time of the same machine learning algorithm and the sample size used in the next learning step.

The machine learning device 100 executes the learning steps 31, 34, and 37 of the machine learning algorithms A to C, respectively. The machine learning device 100 estimates the improvement rates of the machine learning algorithms A to C on the basis of the execution results of the learning steps 31, 34, and 37, respectively. Assuming that the machine learning device 100 has estimated that the improvement rates of the machine learning algorithms A to C are 2.5, 2.0, and 1.0, respectively, the machine learning device 100 selects the machine learning algorithm A that indicates the highest improvement rate and executes the learning step 32.

After executing the learning step 32, the machine learning device 100 updates the improvement rates of the machine learning algorithms A to C. The following description assumes that the machine learning device 100 has estimated the improvement rates of the machine learning algorithms A to C to be 0.73, 1.0, and 0.5, respectively. Since the achieved prediction performance has been increased by the learning step 32, the improvement rates of the machine learning algorithms B and C have also been decreased. The machine learning device 100 selects the machine learning algorithm B that indicates the highest improvement rate and executes the learning step 35.

After executing the learning step 35, the machine learning device 100 updates the improvement rates of the machine learning algorithms A to C. Assuming that the machine learning device 100 has estimated the improvements of the machine learning algorithms A to C to be 0.0, 0.8, and 0.0, respectively, the machine learning device 100 selects the machine learning algorithm B that indicates the highest improvement rate and executes the learning step 36. When the machine learning device 100 determines that the prediction performance has sufficiently been increased by the learning step 36, the machine learning device 100 ends the machine learning. In this case, the machine learning device 100 does not execute the learning step 33 of the machine learning algorithm A and the learning steps 38 and 39 of the machine learning algorithm C.

When estimating the prediction performance of the next learning step, it is preferable that the machine learning device 100 take a statistical error into consideration and reduce the risk of promptly eliminating a machine learning algorithm that generates a model whose prediction performance could increase in the future. For example, the machine learning device 100 may calculate an expected value of the prediction performance and the 95% prediction interval thereof by a regression analysis and use the upper confidence bound (UCB) of the 95% prediction interval as the estimated value of the prediction performance when the improvement rate is calculated. The 95% prediction interval indicates the variation of a measured prediction performance (measured value), and a new prediction performance is expected to fall within this interval with a probability of 95%. Namely, a value larger than a statistically expected value by a width based on a statistical error is used.

Instead of using the UCB, the machine learning device 100 may integrate a distribution of estimated prediction performances to calculate the probability (probability of improvement (PI)) with which the prediction performance exceeds the achieved prediction performance. The machine learning device 100 may integrate a distribution of estimated prediction performances to calculate the expected value (expected improvement (EI)) indicating that the prediction performance exceeds the achieved prediction performance. For example, a statistical-error-related risk is discussed in the following document: Peter Auer, Nicolo Cesa-Bianchi and Paul Fischer, “Finite-time Analysis of the Multiarmed Bandit Problem”, Machine Learning vol. 47, pp. 235-256, 2002.

In accordance with the third method, since the machine learning device 100 does not execute those learning steps that do not contribute to improvement in the prediction performance, the overall learning time is shortened. In addition, the machine learning device 100 preferentially executes a learning step of a machine learning algorithm that indicates the maximum performance improvement amount per unit time. Thus, even when the learning time is limited and the machine learning is stopped before its completion, a model obtained when the machine learning is stopped is the best model obtainable within the time limit. In addition, while learning steps that contribute to relatively small improvement in the prediction performance could be executed later in the execution order, these learning steps could be executed. Thus, the risk of eliminating a machine learning algorithm that could generate a model whose maximum prediction performance is high is reduced.

The following description will be made assuming that the machine learning device 100 performs machine learning in accordance with the third method.

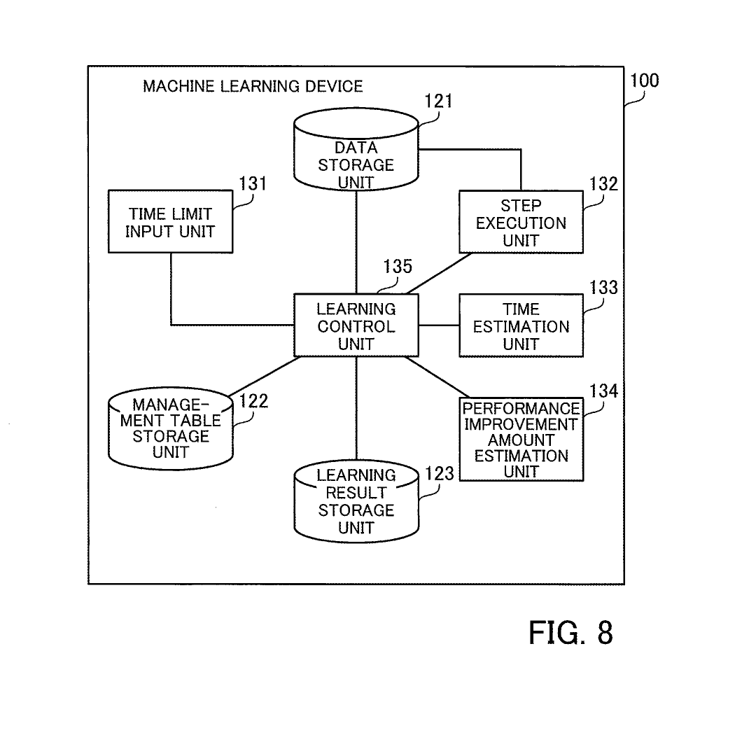

FIG. 8 is a block diagram illustrating an example of functions of the machine learning device 100 according to the second embodiment.

The machine learning device 100 includes a data storage unit 121, a management table storage unit 122, a learning result storage unit 123, a time limit input unit 131, a step execution unit 132, a time estimation unit 133, a performance improvement amount estimation unit 134, and a learning control unit 135. For example, each of the data storage unit 121, the management table storage unit 122, and the learning result storage unit 123 is realized by using a storage area ensured in the RAM 102 or the HDD 103. For example, each of the time limit input unit 131, the step execution unit 132, the time estimation unit 133, the performance improvement amount estimation unit 134, and the learning control unit 135 is realized by using a program module executed by the CPU 101.

The data storage unit 121 holds a data set usable in machine learning. The data set is a set of unit data, and each unit data includes a value of an objective variable (result) and a value of at least one explanatory variable (factor). The machine learning device 100 or a different information processing device may collect the data to be held in the data storage unit 121 via any one of various kinds of device. Alternatively, a user may input the data to the machine learning device 100 or a different information processing device.

The management table storage unit 122 holds a management table for managing advancement of machine learning. The management table is updated by the learning control unit 135. The management table will be described in detail below.

The learning result storage unit 123 holds results of machine learning. A result of machine learning includes a model that indicates a relationship between an objective variable and at least one explanatory variable. For example, a coefficient that indicates weight of an individual explanatory variable is determined by machine learning. In addition, a result of machine learning includes the prediction performance of the learned model. In addition, a result of machine learning includes information about the machine learning algorithm and the sample size used to learn the model.

The time limit input unit 131 acquires information about the time limit of machine learning and notifies the learning control unit 135 of the time limit. The information about the time limit may be inputted by a user via the input device 112. The information about the time limit may be read from a setting file held in the RAM 102 or the HDD 103. The information about the time limit may be received from a different information processing device via the network 114.

The step execution unit 132 is able to execute a plurality of machine learning algorithms. The step execution unit 132 receives a specified machine learning algorithm and a sample size from the learning control unit 135. Next, using the data held in the data storage unit 121, the step execution unit 132 executes a learning step with the specified machine learning algorithm and sample size. Namely, the step execution unit 132 extracts training data and test data from the data storage unit 121 on the basis of the specified sample size. The step execution unit 132 learns a model by using the training data and the specified machine learning algorithm and calculates the prediction performance of the model by using the test data.

When learning a model and calculating the prediction performance thereof, the step execution unit 132 may use any one of various kinds of validation methods such as cross validation or random sub-sampling validation. The validation method used may previously be set in the step execution unit 132. In addition, the step execution unit 132 measures the execution time of an individual learning step. The step execution unit 132 outputs the model, the prediction performance, and the execution time to the learning control unit 135.

The time estimation unit 133 estimates the execution time of the next learning step of a machine learning algorithm. The time estimation unit 133 receives a specified machine learning algorithm and a specified step number that indicates a learning step of the machine learning algorithm from the learning control unit 135. In response, the time estimation unit 133 estimates the execution time of the learning step indicated by the specified step number from the execution time of at least one executed learning step of the specified machine learning algorithm, a sample size that corresponds to the specified step number, and a predetermined estimation expression. The time estimation unit 133 outputs the estimated execution time to the learning control unit 135.

The performance improvement amount estimation unit 134 estimates the performance improvement amount of the next learning step of a machine learning algorithm. The performance improvement amount estimation unit 134 receives a specified machine learning algorithm and a specified step number from the learning control unit 135. In response, the performance improvement amount estimation unit 134 estimates the prediction performance of a learning step indicated by the specified step number from the prediction performance of at least one executed learning step of the specified machine learning algorithm, a sample size that corresponds to the specified step number, and a predetermined estimation expression. When estimating this prediction performance, the performance improvement amount estimation unit 134 takes a statistical error into consideration and uses a value larger than an expected value of the prediction performance such as the UCB. The performance improvement amount estimation unit 134 calculates the improvement amount from the currently achieved prediction performance and outputs the improvement amount to the learning control unit 135.

The learning control unit 135 controls machine learning that uses a plurality of machine learning algorithms. The learning control unit 135 causes the step execution unit 132 to execute the first learning step of each of the plurality of machine learning algorithms. Every time a single learning step is executed, the learning control unit 135 causes the time estimation unit 133 to estimate the execution time of the next learning step of the same machine learning algorithm and causes the performance improvement amount estimation unit 134 to estimate the performance improvement amount of the next learning step. The learning control unit 135 divides a performance improvement amount by the corresponding execution time to calculate an improvement rate.

In addition, the learning control unit 135 selects one of the plurality of machine learning algorithms that indicates the highest improvement rate and causes the step execution unit 132 to execute the next learning step of the selected machine learning algorithm. The learning control unit 135 repeatedly updates the improvement rates and selects a machine learning algorithm until the prediction performance satisfies a predetermined stopping condition or the learning time exceeds a time limit. Among the models obtained until the machine learning is stopped, the learning control unit 135 stores a model that indicates the highest prediction performance in the learning result storage unit 123. In addition, the learning control unit 135 stores information about the prediction performance and the machine learning algorithm and information about the sample size in the learning result storage unit 123.

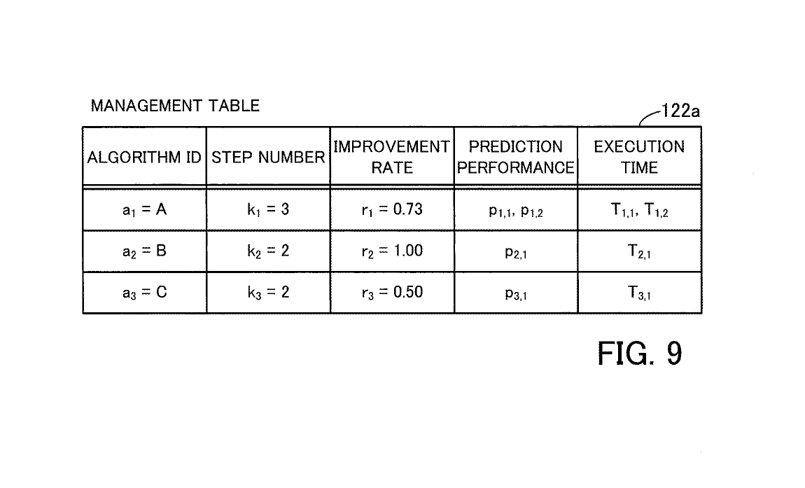

FIG. 9 illustrates an example of a management table 122a.

The management table 122a is generated by the learning control unit 135 and is held in the management table storage unit 122. The management table 122a includes columns for “algorithm ID,” “step number,” “improvement rate,” “prediction performance,” and “execution time.”

An individual box under “algorithm ID” represents identification information for identifying a machine learning algorithm. In the following description, the algorithm ID of the i-th machine learning algorithm (i is an integer) will be denoted as aᵢ as needed. An individual box under “step number” represents a number that indicates a learning step used in progressive sampling. In the management table 122a, the step number of the learning step that is executed next is registered per machine learning algorithm. In the following description, the step number of the i-th machine learning algorithm will be denoted as kᵢ as needed.

In addition, a sample size is uniquely determined from a step number. In the following description, the sample size of the j-th learning step will be denoted as sⱼ as needed. Assuming that the data set stored in the data storage unit 121 is denoted by D and the size of the data set D (the number of unit data) is denoted by |D|, for example, s₁ is determined to be |D|/2¹⁰ and sⱼ is determined to be s₁×2^{j-1}.

Per machine learning algorithm, in a box under “improvement rate”, the estimated improvement rate of the learning step that is executed next is registered. For example, the unit of the improvement rate is [seconds⁻¹]. In the following description, the improvement rate of the i-th machine learning algorithm will be denoted as rᵢ as needed. Per machine learning algorithm, in a box under “prediction performance”, the prediction performance of at least one learning step that has already been executed is listed. In the following description, the prediction performance calculated in the j-th learning step of the i-th machine learning algorithm will be denoted as p_{i,j} as needed. Per machine learning algorithm, in a box under “execution time”, the execution time of at least one learning step that has already been executed is listed. For example, the unit of the execution time is [seconds]. In the following description, the execution time of the j-th learning step of the i-th machine learning algorithm will be denoted as T_{i,j} as needed.

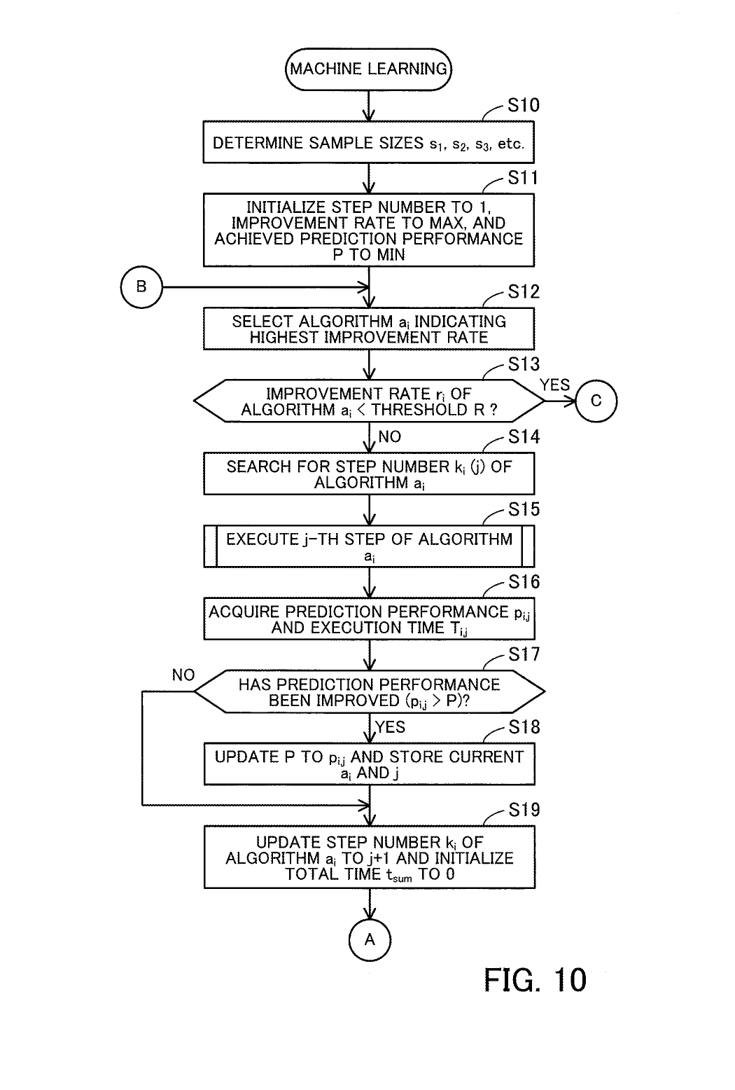

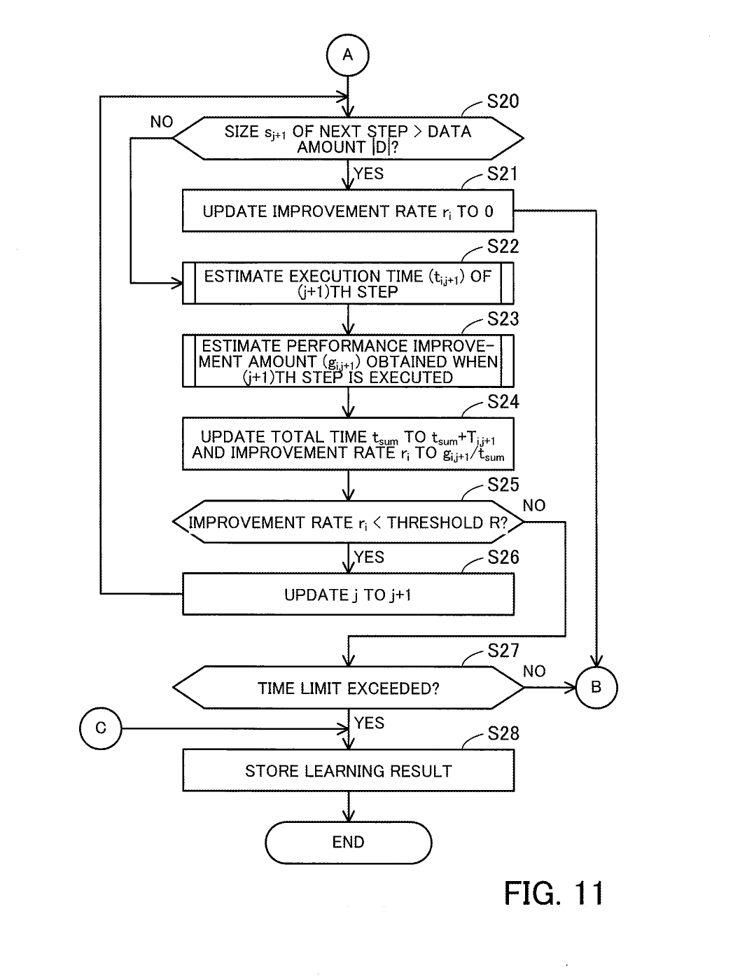

FIGS. 10 and 11 are flowcharts illustrating an example of a procedure of machine learning according to the second embodiment.

(S10) The learning control unit 135 refers to the data storage unit 121 and determines sample sizes s₁, s₂, s₃, etc. of the learning steps in accordance with progressive sampling. For example, the learning control unit 135 determines that s₁ is |D|/2¹⁰ and that sⱼ is s₁×2^{j-1} on the basis of the size of the data set D stored in the data storage unit 121.

(S11) The learning control unit 135 initializes the step number of an individual machine learning algorithm in the management table 122a to 1. In addition, the learning control unit 135 initializes the improvement rate of an individual machine learning algorithm to a maximal possible value. In addition, the learning control unit 135 initializes the achieved prediction performance P to a minimum possible value (for example, 0).

(S12) The learning control unit 135 selects a machine learning algorithm that indicates the highest improvement rate from the management table 122a. The selected machine learning algorithm will be denoted by aᵢ.

(S13) The learning control unit 135 determines whether the improvement rate rᵢ of the machine learning algorithm aᵢ is less than a threshold R. The threshold R may be set in advance by the learning control unit 135. For example, the threshold R is 0.001/3600 [seconds⁻¹]. If the improvement rate rᵢ is less than the threshold R, the operation proceeds to step S28. Otherwise, the operation proceeds to step S14.

(S14) The learning control unit 135 searches the management table 122a for a step number kᵢ of the machine learning algorithm aᵢ. The following description will be made assuming that kᵢ is j.

(S15) The learning control unit 135 calculates a sample size sⱼ that corresponds to the step number j and specifies the machine learning algorithm aᵢ and the sample size sⱼ to the step execution unit 132. The step execution unit 132 executes the j-th learning step of the machine learning algorithm aᵢ. The processing of the step execution unit 132 will be described in detail below.

(S16) The learning control unit 135 acquires the learned model, the prediction performance p_{i,j} thereof, and the execution time T_{i,j} from the step execution unit 132.

(S17) The learning control unit 135 compares the prediction performance p_{i,j} acquired in step S16 with the achieved prediction performance P (the maximum prediction performance achieved up until now) and determines whether the former is larger than the latter. If the prediction performance p_{i,j} is larger than the achieved prediction performance P, the operation proceeds to step S18. Otherwise, the operation proceeds to step S19.

(S18) The learning control unit 135 updates the achieved prediction performance P to the prediction performance p_{i,j}. In addition, the learning control unit 135 stores the machine learning algorithm aᵢ and the step number j in association with the achieved prediction performance P in the management table 122a.

(S19) Among the step numbers stored in the management table 122a, the learning control unit 135 updates the step number kᵢ of the machine learning algorithm aᵢ to j+1. Namely, the step number kᵢ is incremented by 1 (1 is added to the step number kᵢ). In addition, the learning control unit 135 initializes the total time tₛᵤₘ to 0.

(S20) The learning control unit 135 calculates the sample size sⱼ₊₁ of the next learning step of the machine learning algorithm aᵢ. The learning control unit 135 compares the sample size sⱼ₊₁ with the size of the data set D stored in the data storage unit 121 and determines whether the former is larger than the latter. If the sample size sⱼ₊₁ is larger than the size of the data set D, the operation proceeds to step S21. Otherwise, the operation proceeds to step S22.

(S21) Among the improvement rates stored in the management table 122a, the learning control unit 135 updates the improvement rate rᵢ of the machine learning algorithm aᵢ to 0. In this way, the machine learning algorithm aᵢ will not be executed. Next, the operation returns to the above step S12.

(S22) The learning control unit 135 specifies the machine learning algorithm aᵢ and the step number j+1 to the time estimation unit 133. The time estimation unit 133 estimates an execution time t_{i,j+1} needed when the next learning step (the (j+1)th learning step) of the machine learning algorithm aᵢ is executed. The processing of the time estimation unit 133 will be described in detail below.

(S23) The learning control unit 135 specifies the machine learning algorithm aᵢ and the step number j+1 to the performance improvement amount estimation unit 134. The performance improvement amount estimation unit 134 estimates a performance improvement amount g_{i,j+1} obtained when the next learning step (the (j+1)th learning step) of the machine learning algorithm aᵢ is executed. The processing of the performance improvement amount estimation unit 134 will be described in detail below.

(S24) On the basis of the execution time t_{i,j+1} acquired from the time estimation unit 133, the learning control unit 135 updates the total time tₛᵤₘ to tₛᵤₘ+t_{i,j+1}. In addition, on the basis of the updated total time tₛᵤₘ and the performance improvement amount g_{i,j+1} acquired from the performance improvement amount estimation unit 134, the learning control unit 135 updates the improvement rate rᵢ to g_{i,j+1}/tₛᵤₘ. The learning control unit 135 updates the improvement rate rᵢ stored in the management table 122a to the above updated value.

(S25) The learning control unit 135 determines whether the improvement rate rᵢ is less than the threshold R. If the improvement rate rᵢ is less than the threshold R, the operation proceeds to step S26. Otherwise, the operation proceeds to step S27.

(S26) The learning control unit 135 updates j to j+1. Next, the operation returns to step S20.

(S27) The learning control unit 135 determines whether the time that has elapsed since the start of the machine learning has exceeded the time limit specified by the time limit input unit 131. If the elapsed time has exceeded the time limit, the operation proceeds to step S28. Otherwise, the operation returns to step S12.

(S28) The learning control unit 135 stores the achieved prediction performance P and the model that has achieved the prediction performance in the learning result storage unit 123. In addition, the learning control unit 135 stores the algorithm ID of the machine learning algorithm associated with the achieved prediction performance P and the sample size that corresponds to the step number associated with the achieved prediction performance P in the learning result storage unit 123.

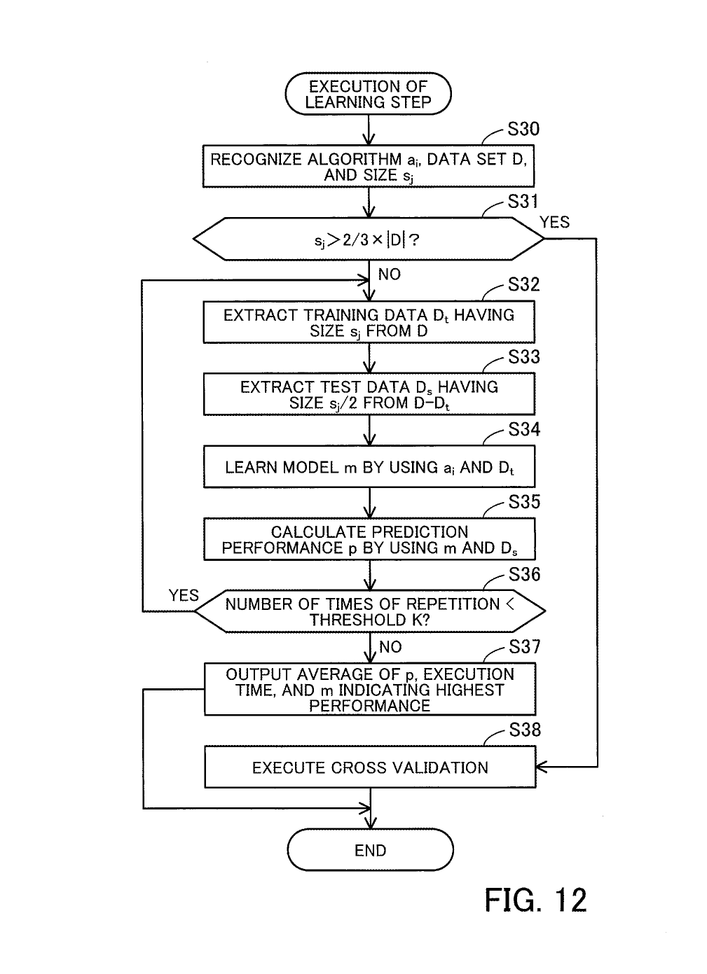

FIG. 12 is a flowchart illustrating an example of a procedure of execution of a learning step according to the second embodiment.

Hereinafter, random sub-sampling validation or cross validation is executed as the validation method, depending on the size of the data set D. The step execution unit 132 may use a different validation method.

(S30) The step execution unit 132 recognizes the machine learning algorithm aᵢ and the sample size sⱼ specified by the learning control unit 135. In addition, the step execution unit 132 recognizes the data set D stored in the data storage unit 121.

(S31) The step execution unit 132 determines whether the sample size sⱼ is larger than ⅔ of the size of the data set D. If the sample size sⱼ is larger than ⅔×|D|, the step execution unit 132 selects cross validation since the data amount is insufficient. Namely, the operation proceeds to step S38. If the sample size sⱼ is equal to or less than ⅔×|D|, the step execution unit 132 selects random sub-sampling validation since the data amount is sufficient. Namely, the operation proceeds to step S32.

(S32) The step execution unit 132 randomly extracts the training data Dₜ having the sample size sⱼ from the data set D. The extraction of the training data is performed as a sampling operation without replacement. Thus, the training data includes sⱼ unit data different from each other.

(S33) The step execution unit 132 randomly extracts test data Dₛ having the size sⱼ/2 from the portion indicated by (data set D−training data Dₜ). The extraction of the test data is performed as a sampling operation without replacement. Thus, the test data includes sⱼ/2 unit data that is different from the training data Dₜ and that is different from each other. While the ratio between the size of the training data Dₜ and the size of the test data Dₛ is 2:1 in this example, a different ratio may be used.

(S34) The step execution unit 132 learns a model m by using the machine learning algorithm aᵢ and the training data Dₜ extracted from the data set D.

(S35) The step execution unit 132 calculates the prediction performance p of the model m by using the learned model m and the test data Dₛ extracted from the data set D. Any index such as the accuracy, the precision, the RMSE may be used as the index that represents the prediction performance p. The index that represents the prediction performance p may be set in advance in the step execution unit 132.

(S36) The step execution unit 132 compares the number of times of the repetition of the above steps S32 to S35 with a threshold K and determines whether the former is less than the latter. The threshold K may be previously set in the step execution unit 132. For example, the threshold K is 10. If the number of times of the repetition is less than the threshold K, the operation returns to step S32. Otherwise, the operation proceeds to step S37.

(S37) The step execution unit 132 calculates an average value of the K prediction performances p calculated in step S35 and outputs the average value as a prediction performance p_{i,j}. In addition, the step execution unit 132 calculates and outputs the execution time T_{i,j} needed from the start of step S30 to the end of the repetition of the above steps S32 to S36. In addition, the step execution unit 132 outputs a model that indicates the highest prediction performance p among the K models m learned in step S34. In this way, a single learning step with random sub-sampling validation is ended.

(S38) The step execution unit 132 executes the above cross validation, instead of the above random sub-sampling validation. For example, the step execution unit 132 randomly extracts sample data having the sample size sⱼ from the data set D and equally divides the extracted sample data into K blocks. The step execution unit 132 repeats using the (K−1) blocks as the training data and 1 block as the test data K times while changing the block used as the test data. The step execution unit 132 outputs an average value of the K prediction performances, the execution time, and a model that indicates the highest prediction performance.

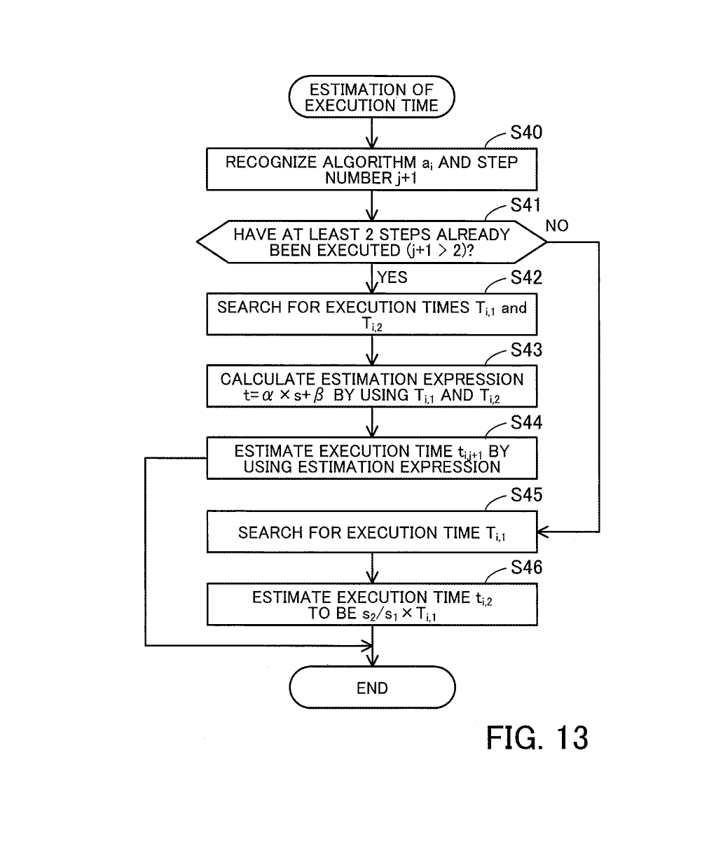

FIG. 13 is a flowchart illustrating an example of a procedure of execution of time estimation.

(S40) The time estimation unit 133 recognizes the machine learning algorithm aᵢ and the step number j+1 specified by the learning control unit 135.

(S41) The time estimation unit 133 determines whether at least two learning steps of the machine learning algorithm aᵢ have been executed, namely, determines whether the step number j+1 is larger than 2. If j+1>2, the operation proceeds to step S42. Otherwise, the operation proceeds to step S45.

(S42) The time estimation unit 133 searches the management table 122a for execution times T_{i,1} and T_{i,2} that correspond to the machine learning algorithm aᵢ.

(S43) By using the sample sizes s₁ and s₂ and the execution times T_{i,1} and T_{i,2}, the time estimation unit 133 determines coefficients α and β in an estimation expression t=α×s+β for estimating an execution time t from a sample size s. The coefficients α and β can be determined by solving a simultaneous equation formed by an expression in which T_{i,1} and s₁ are assigned to t and s, respectively, and an expression in which T_{i,2} and s₂ are assigned to t and s, respectively. If three or more learning steps of the machine learning algorithm aᵢ have already been executed, the time estimation unit 133 may determine the coefficients α and β through a regression analysis based on the execution times of the learning steps. Assuming an execution time as a linear expression using a sample size is also discussed in the above document (“The Learning-Curve Sampling Method Applied to Model-Based Clustering”).

(S44) The time estimation unit 133 estimates the execution time t_{i,j+1} of the (j+1)th learning step by using the above estimation expression and the sample size sⱼ₊₁ (by assigning sⱼ₊₁ to s in the estimation expression). The time estimation unit 133 outputs the estimated execution time t_{i,j+1}.

(S45) The time estimation unit 133 searches the management table 122a for the execution time T_{i,1} that corresponds to the machine learning algorithm aᵢ.

(S46) The time estimation unit 133 estimates the execution time t_{i,2} Of the second learning step to be s₂/s₁×T_{i,1} by using the sample size s₁ and s₂ and the execution time T_{i,1}. The time estimation unit 133 outputs the estimated execution time t_{i,2}.

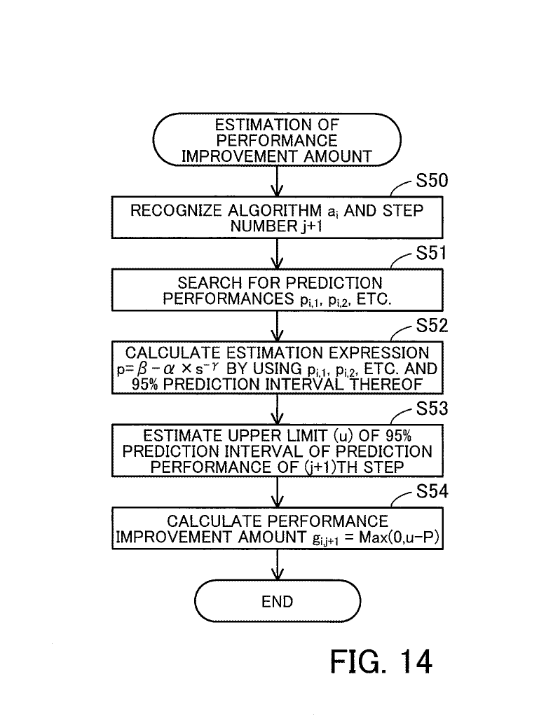

FIG. 14 is a flowchart illustrating an example of a procedure of estimation of a performance improvement amount.

(S50) The performance improvement amount estimation unit 134 recognizes the machine learning algorithm aᵢ and the step number j+1 specified by the learning control unit 135.

(S51) The performance improvement amount estimation unit 134 searches the management table 122a for all the prediction performances p_{i,1}, P_{i,2}, and so on that correspond to the machine learning algorithm aᵢ.

(S52) The performance improvement amount estimation unit 134 determines coefficients α, β, and γ in an estimation expression p=β−+×s^{-γ} for estimating the prediction performance p from the sample size s, by using the sample sizes s₁, s₂, and so on and the prediction performances p_{i,1}, p_{i,2}, and so on. The coefficients α, β, and γ may be determined by fitting the sample sizes s₁, s₂, and so on and the prediction performances p_{i,1}, p_{i,2}, and so on in the above curve through a non-linear regression analysis. In addition, the performance improvement amount estimation unit 134 calculates the 95% prediction interval of the above curve. The above curve is also discussed in the following document: Prasanth Kolachina, Nicola Cancedda, Marc Dymetman and Sriram Venkatapathy, “Prediction of Learning Curves in Machine Translation”, Proc. of the 50th Annual Meeting of the Association for Computational Linguistics, pp. 22-30, 2012.

(S53) By using the 95% prediction interval of the estimation expression and the sample size sⱼ₊₁, the performance improvement amount estimation unit 134 calculates the upper limit (UCB) of the 95% prediction interval of the prediction performance of the (j+1)th learning step and determines the result to be an estimated upper limit u.

(S54) The performance improvement amount estimation unit 134 estimates a performance improvement amount g_{i,j+1} by comparing the currently achieved prediction performance P with the estimated upper limit u and outputs the estimated performance improvement amount g_{i,j+1}. The performance improvement amount g_{i,j+1} is determined to be u-P if u>P and to be 0 if u≦P.

The machine learning device 100 according to the second embodiment estimates the improvement amount (improvement rate) of the prediction performance per unit time when the next learning step of an individual machine learning algorithm is executed. The machine learning device 100 selects one of the machine learning algorithms that indicates the highest improvement rate and advances the learning step of the selected machine learning algorithm by one level. The machine learning device 100 repeats estimating the improvement rates and selecting a machine learning algorithm and finally selects a single model.

In this way, since those learning steps that do not contribute to improvement in the prediction performance are not executed, the overall learning time is shortened. In addition, since a machine learning algorithm that indicates the highest estimated improvement rate is selected, even when there is a limit to the learning time and the machine learning is stopped before its completion, a model obtained when the machine learning is stopped is the best model obtainable within the time limit. While learning steps that contribute to relatively small improvement in the prediction performance could be executed later in the execution order, these learning steps could be executed. Thus, the risk of eliminating a machine learning algorithm that could generate a model whose maximum prediction performance is high when the sample size is still small is reduced. As described above, by using a plurality of machine learning algorithms, the prediction performance of a finally used model is efficiently improved.

### Third Embodiment

Next, a third embodiment will be described. The third embodiment will be described with a focus on the difference from the second embodiment, and the description of the same features according to the third embodiment as those according to the second embodiment will be omitted as needed.

In the case of the machine learning device 100 according to the second embodiment, the relationship between the sample size s and the execution time t of a learning step is represented by a liner expression. However, the relationship between the sample size s and the execution time t could significantly vary depending on the machine learning algorithm. For example, in the case of some machine learning algorithms, the execution time t does not increase proportionally as the sample size s increases. Thus, depending on the machine learning algorithm, a machine learning device 100a according to the third embodiment uses a different estimation expression when estimating the execution time t.

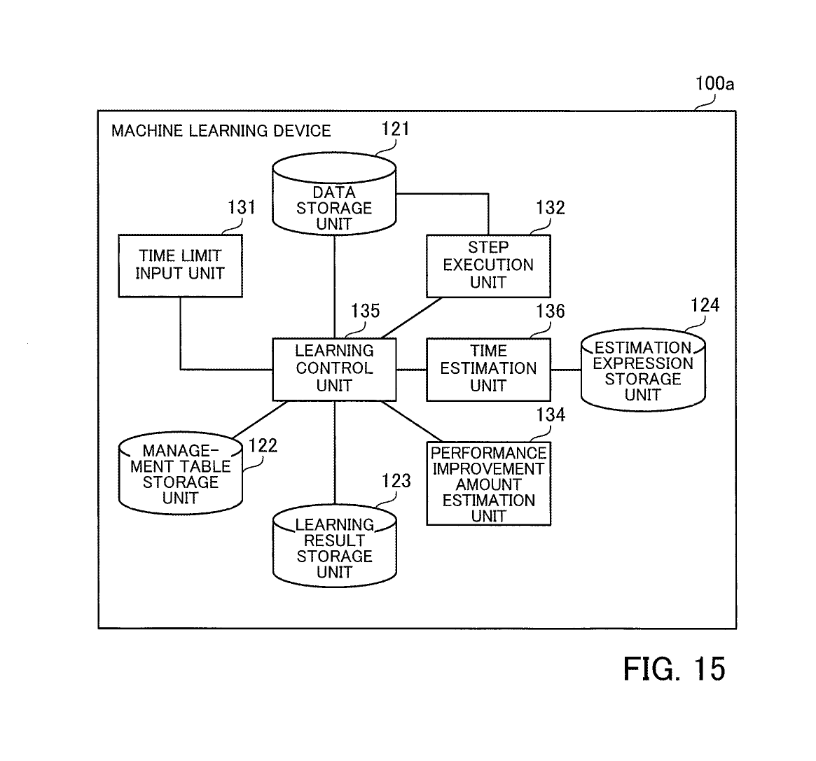

FIG. 15 is a block diagram illustrating an example of functions of the machine learning device 100a according to the third embodiment.

The machine learning device 100a includes a data storage unit 121, a management table storage unit 122, a learning result storage unit 123, an estimation expression storage unit 124, a time limit input unit 131, a step execution unit 132, a performance improvement amount estimation unit 134, a learning control unit 135, and a time estimation unit 136. The machine learning device 100a includes the time estimation unit 136 instead of the time estimation unit 133 according to the second embodiment. The estimation expression storage unit 124 may be realized by using a storage area ensured in the RAM or the HDD, for example. The time estimation unit 136 may be realized by using a program module executed by the CPU, for example. The machine learning device 100a may be realized by using the same hardware as that of the machine learning device 100 according to the second embodiment illustrated in FIG. 2.

The estimation expression storage unit 124 holds an estimation expression table. The estimation expression table holds an estimation expression per machine learning algorithm, and each estimation expression represents the relationship between the sample size s and the execution time t of the corresponding machine learning algorithm. The estimation expression per machine learning algorithm is determined in advance by a user. For example, the user previously executes an individual machine learning algorithm by using different sizes of training data and measures the execution times. In addition, the user previously executes statistical processing such as a non-linear regression analysis and determines an estimation expression from the sample size and the execution time.

The time estimation unit 136 refers to the estimation expression table stored in the estimation expression storage unit 124 and estimates the execution time of the next learning step of a machine learning algorithm. The time estimation unit 136 receives a specified machine learning algorithm and step number from the learning control unit 135. In response, the time estimation unit 136 searches the estimation expression table for an estimation expression that corresponds to the specified machine learning algorithm. The time estimation unit 136 estimates the execution time of the learning step that corresponds to the specified step number from the sample size that corresponds to the specified step number and the found estimation expression and outputs the estimated execution time to the learning control unit 135.

The curve that indicates the increase of the execution time depends not only on the machine learning algorithm but also various execution environments such as the hardware performance such as the processor capabilities, memory capacity, and cache capacity, the implementation method of the program that executes machine learning, and the nature of the data used in machine learning. Thus, the time estimation unit 136 does not directly use an estimation expression stored in the estimation expression table but applies a correction coefficient to the estimation expression. Namely, by comparing the past execution time of an executed learning step with an estimated value calculated by the estimation expression, the time estimation unit 136 calculates a correction coefficient applied to the estimation expression.

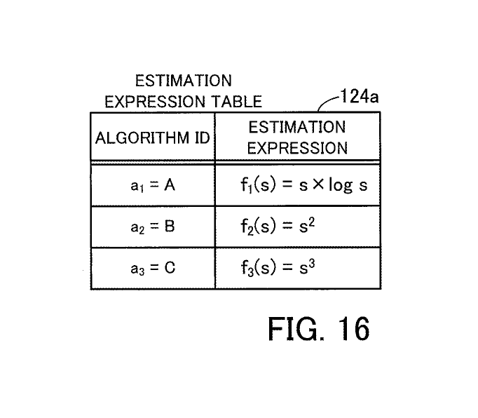

FIG. 16 illustrates an example of an estimation expression table 124a.

The estimation expression table 124a is held in the estimation expression storage unit 124. The estimation expression table 124a includes columns for “algorithm ID” and “estimation expression.”

Each algorithm ID identifies a machine learning algorithm. In each box under “estimation expression,” an estimation expression is registered. Each estimation expression uses the sample size s as an argument. As described above, since the time estimation unit 136 calculates a correction coefficient later, the estimation expression does not need to include a coefficient that affects the entire estimation expression. In the following description, the estimation expression that corresponds to the machine learning algorithm aᵢ will be denoted as fᵢ(s) as needed.

For example, the estimation expression that corresponds to the machine learning algorithm A will be denoted as fᵢ(s)=s×log s, the estimation expression that corresponds to the machine learning algorithm B as f₂(s)=s², and the estimation expression that corresponds to the machine learning algorithm C as f₃(s)=s³. Thus, when a certain machine learning algorithm is used, the execution time increases more sharply, compared with the execution times of other machine learning algorithms that are indicated by a line (linear expression).

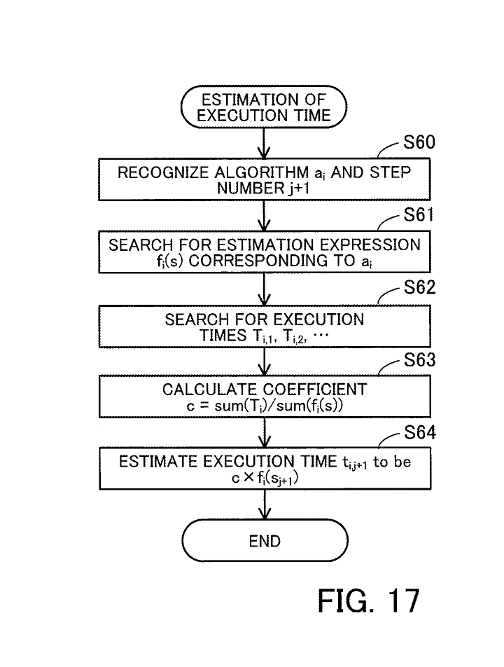

FIG. 17 is a flowchart illustrating an example of another procedure of execution of time estimation.

(S60) The time estimation unit 136 recognizes the specified machine learning algorithm aᵢ and step number j+1 from the learning control unit 135.

(S61) The time estimation unit 136 searches the estimation expression table 124a for the estimation expression fᵢ(s) that corresponds to the machine learning algorithm aᵢ.

(S62) The time estimation unit 136 searches the management table 122a for all the execution times T_{i,1}, T_{i,2}, . . . that correspond to the machine learning algorithm aᵢ.

(S63) By using the sample sizes s₁, s₂, . . . the execution times T_{i,1}, T_{i,2}, . . . , and the estimation expression fᵢ(s), the time estimation unit 136 calculates a correction coefficient c by which the estimation expression fᵢ(s) is multiplied. For example, the time estimation unit 136 calculates the correction coefficient c as sum(Tᵢ)/sum(fᵢ(s)) wherein sum(Tᵢ) is a value obtained by adding T_{i,1}, T_{i,2}, . . . , which are the result values of the execution times. The sum(fᵢ(s)) is a value obtained by adding fᵢ(sᵢ), fᵢ(s₂), . . . , which are the estimated values uncorrected. An individual uncorrected estimated value can be calculated by assigning a sample size to the estimation expression. Namely, the correction coefficient c represents the ratio of the result values to the uncorrected estimated values.

(S64) The time estimation unit 136 estimates the execution time t_{i,j+1} of the (j+1)th learning step by using the estimation expression fᵢ(s), the corrected coefficient c, and the sample size sⱼ₊₁. More specifically, the execution time t_{i,j+1} is calculated by c×fᵢ(sⱼ₊₁). The time estimation unit 136 outputs the estimated execution time t_{i,j+1}.

The machine learning device 100a according to the third embodiment provides the same advantageous effects as those provided by the machine learning device 100 according to the second embodiment. In addition, according to the third embodiment, the execution time of the next learning step is estimated more accurately. As a result, since the improvement rate of the prediction performance is estimated more accurately, the risk of erroneously selecting a machine learning algorithm that indicates a low improvement rate is reduced. Thus, a model that indicates a high prediction performance is obtained within a shorter learning time.

### Fourth Embodiment

Next, a fourth embodiment will be described. The fourth embodiment will be described with a focus on the difference from the second embodiment, and the description of the same features according to the fourth embodiment as those according to the second embodiment will be omitted as needed.

It is often the case that an individual machine learning algorithm includes at least one hyperparameter in order to control its operation. Unlike a coefficient (parameter) included in a model, the value of a hyperparameter is not determined through machine learning but is given before a machine learning algorithm is executed. Examples of the hyperparameter include the number of decision trees generated in a random forest, the fitting precision in a regression analysis, and the degree of a polynomial included in a model. As the value of the hyperparameter, a fixed value or a value specified by a user may be used.

However, the prediction performance of a model depends on the value of the hyperparameter. Even when the same machine learning algorithm and sample size are used, if the value of the hyperparameter changes, the prediction performance of the model could change. It is often the case that the value of the hyperparameter that achieves the highest prediction performance is not known in advance. Thus, in the fourth embodiment, a hyperparameter is automatically adjusted through the entire machine learning. Hereinafter, a set of hyperparameters applied to a machine learning algorithm will be referred to as a “hyperparameter vector,” as needed.

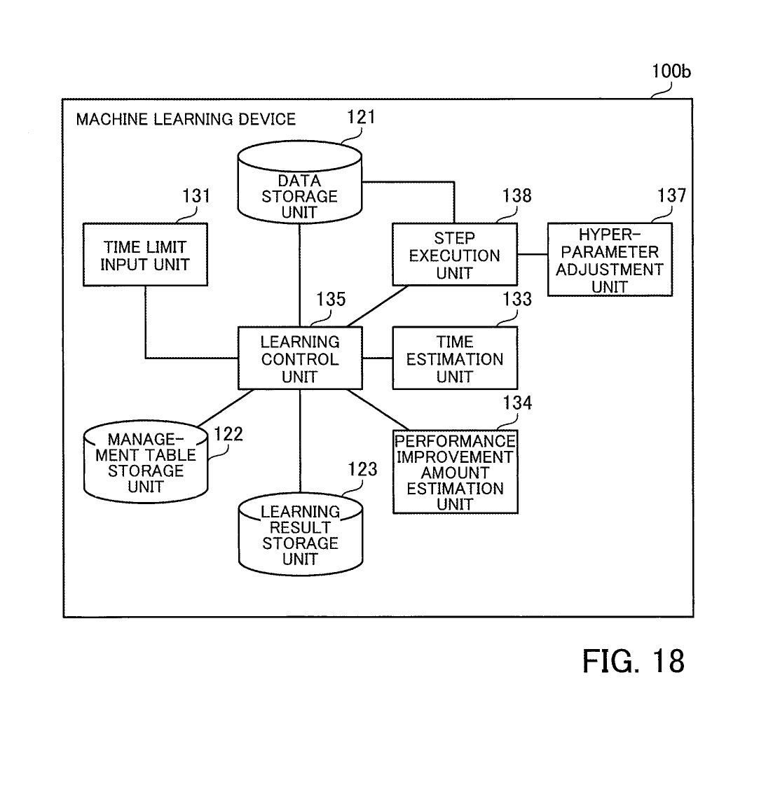

FIG. 18 is a block diagram illustrating an example of functions of a machine learning device 100b according to the fourth embodiment.

The machine learning device 100b includes a data storage unit 121, a management table storage unit 122, a learning result storage unit 123, a time limit input unit 131, a time estimation unit 133, a performance improvement amount estimation unit 134, a learning control unit 135, a hyperparameter adjustment unit 137, and a step execution unit 138. The machine learning device 100b includes the step execution unit 138 instead of the step execution unit 132 according to the second embodiment. Each of the hyperparameter adjustment unit 137 and the step execution unit 138 may be realized by using a program module executed by the CPU, for example. The machine learning device 100b may be realized by using the same hardware as that of the machine learning device 100 according to the second embodiment illustrated in FIG. 2.

In response to a request from the step execution unit 138, the hyperparameter adjustment unit 137 generates a hyperparameter vector applied to a machine learning algorithm to be executed by the step execution unit 138. Grid search or random search may be used to generate the hyperparameter vector. Alternatively, a method using a Gaussian process, a sequential model-based algorithm configuration (SMAC), or a Tree Parzen Estimator (TPE) may be used to generate the hyperparameter vector.

For example, the following document discusses the method using a Gaussian process. Jasper Snoek, Hugo Larochelle and Ryan P. Adams, “Practical Bayesian Optimization of Machine Learning Algorithms”, In Advances in Neural Information Processing Systems 25 (NIPS '12), pp. 2951-2959, 2012. For example, the following document discusses the SMAC. Frank Hutter, Holger H. Hoos and Kevin Leyton-Brown, “Sequential Model-Based Optimization for General Algorithm Configuration”, In Lecture Notes in Computer Science, Vol. 6683 of Learning and Intelligent Optimization, pp. 507-523. Springer, 2011. For example, the following document discusses the TPE. James Bergstra, Remi Bardenet, Yoshua Bengio and Balazs Kegl, “Algorithms for Hyper-Parameter Optimization”, In Advances in Neural Information Processing Systems 24 (NIPS '11), pp. 2546-2554, 2011.

The hyperparameter adjustment unit 137 may refer to a hyperparameter vector used in the last learning step of the same machine learning algorithm, to make the search for a preferable hyperparameter vector more efficient. For example, the hyperparameter adjustment unit 137 may perform the search by starting with a hyperparameter vector θⱼ₋ᵢ that achieved the best prediction performance in the last learning step. For example, this method is discussed in the following document. Matthias Feurer, Jost Tobias Springenberg and Frank Hutter, “Initializing Bayesian Hyperparameter Optimization via Meta-Learning”, In Twenty-Ninth AAAI Conference on Artificial Intelligence (AAAI-15), pp. 1128-1135, 2015.

In addition, assuming that the hyperparameter vectors that achieved the best prediction performance in the last two learning steps are θⱼ₋₁ and θⱼ₋₂, respectively, the hyperparameter adjustment unit 137 may generate 2θⱼ₋₁−θⱼ₋₂ as the hyperparameter vector to be used next. This is based on the assumption that a hyperparameter vector that achieves the best prediction performance changes as the sample size changes. Alternatively, the hyperparameter adjustment unit 137 may generate a hyperparameter vector that achieved an above-average prediction performance in the last step and a hyperparameter vector near the hyperparameter vector and uses the vectors this time.

The step execution unit 138 receives a specified machine learning algorithm and sample size from the learning control unit 135. Next, the step execution unit 138 acquires a hyperparameter vector by transmitting a request to the hyperparameter adjustment unit 137. Next, by using the data stored in the data storage unit 121 and the acquired hyperparameter vector, the step execution unit 138 executes a learning step of the specified machine learning algorithm with the specified sample size. The step execution unit 138 repeats machine learning using a plurality of hyperparameter vectors in a single learning step.

Next, the step execution unit 138 selects a model that indicates the best prediction performance from a plurality of models that correspond to the plurality of hyperparameter vectors. The step execution unit 138 outputs the selected model, the prediction performance thereof, the hyperparameter vector used to generate the model, and the execution time. The execution time may be the entire time of the single learning step (the total time that corresponds to the plurality of hyperparameter vectors) or the time needed to learn the selected model (the time that corresponds to the single hyperparameter vector). The learning result held in the learning result storage unit 123 includes the hyperparameter vector, in addition to the model, the prediction performance, the machine learning algorithm, and the sample size.

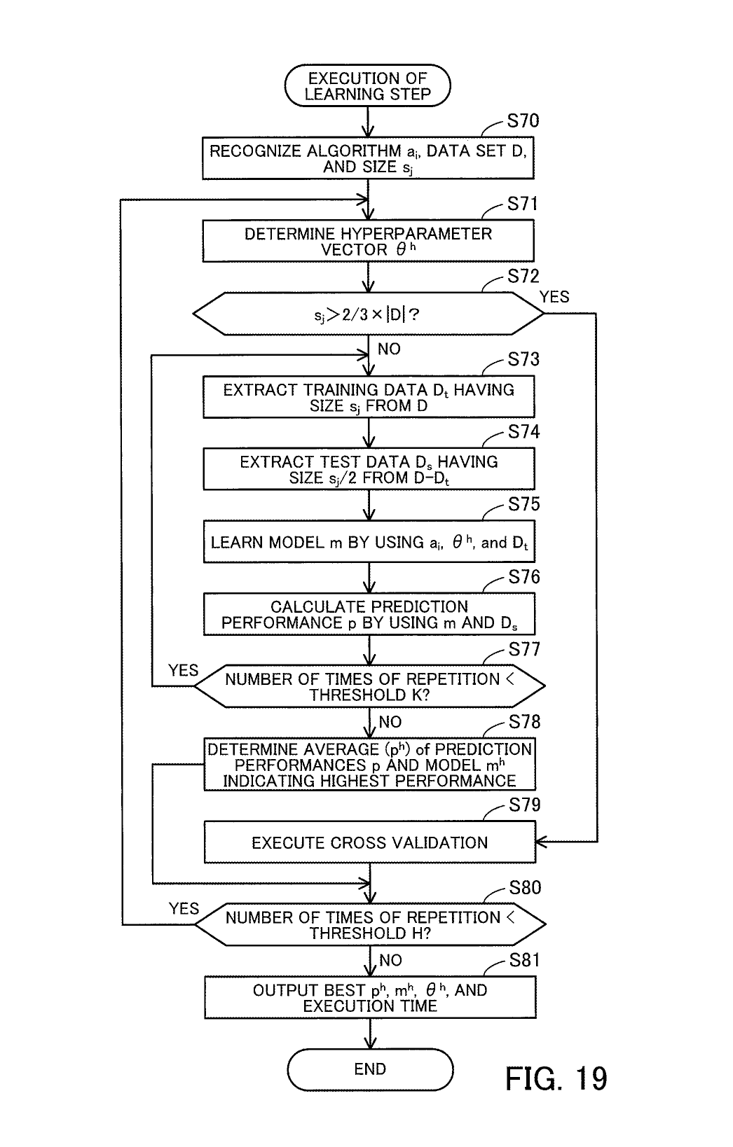

FIG. 19 is a flowchart illustrating an example of a procedure of execution of a learning step according to the fourth embodiment.

(S70) The step execution unit 138 recognizes the machine learning algorithm aᵢ and sample size sⱼ specified by the learning control unit 135. In addition, the step execution unit 138 recognizes the data set D held in the data storage unit 121.

(S71) The step execution unit 138 requests the hyperparameter adjustment unit 137 for a hyperparameter vector to be used next. The hyperparameter adjustment unit 137 determines a hyperparameter vector θ^{h} in accordance with the above method.

(S72) The step execution unit 138 determines whether the sample size sⱼ is larger than ⅔ of the size of the data set D. If the sample size sⱼ is larger than ⅔×|D|, the operation proceeds to step S79. If the sample size sⱼ is equal to or less than ⅔×|D|, the operation proceeds to step S73.

(S73) The step execution unit 138 randomly extracts training data Dₜ having the sample size sⱼ from the data set D.

(S74) The step execution unit 138 randomly extracts test data Dₛ having size sⱼ/2 from the portion indicated by (data set D−training data Dₜ).

(S75) The step execution unit 138 learns a model m by using the machine learning algorithm aᵢ, the hyperparameter vector θ^{h}, and the training data Dₜ.

(S76) The step execution unit 138 calculates the prediction performance p of the model m by using the learned model m and the test data Dₛ.

(S77) The step execution unit 138 compares the number of times of the repetition of the above steps S73 to S76 with a threshold K and determines whether the former is less than the latter. For example, the threshold K is 10. If the number of times of the repetition is less than the threshold K, the operation returns to step S73. If the number of times of the repetition reaches the threshold K, the operation proceeds to step S78.

(S78) The step execution unit 138 calculates the average value of the K prediction performances p calculated in step S76 as a prediction performance p^{h} that corresponds to the hyperparameter vector θ^{h}. In addition, the step execution unit 138 determines a model that indicates the highest prediction performance p among the K models m learned in step S75 and determines the model to be a model m^{h} that corresponds to the hyperparameter vector θ^{h}. Next, the operation proceeds to step S80.

(S79) The step execution unit 138 executes cross validation instead of the above random sub-sampling validation. Next, the operation proceeds to step S80.

(S80) The step execution unit 138 compares the number of times of the repetition of the above steps S71 to S79 with a threshold H and determines whether the former is less than the latter. If the number of times of the repetition is less than the threshold H, the operation returns to step S71. If the number of times of the repetition reaches the threshold H, the operation proceeds to step S81. Note that h=1, 2, . . . , H. H is a predetermined number, e.g., 30.

(S81) The step execution unit 138 outputs the highest prediction performance among the prediction performances p¹, p², . . . , p^{H} as the prediction performance p_{i,j}. In addition, the step execution unit 138 outputs a model that corresponds to the prediction performance p_{i,j} among the models m¹, m², . . . , m^{H}. In addition, the step execution unit 138 outputs a hyperparameter vector that corresponds to the prediction performance p_{i,j} among the hyperparameter vectors θ¹, θ², . . . , θ^{H}. In addition, the step execution unit 138 calculates and outputs an execution time. The execution time may be the entire time needed to execute the single learning step from step S70 to step S81 or the time needed to execute steps S72 to S79 from which the outputted model is obtained. In this way, a single learning step is ended.

The machine learning device 100b according to the fourth embodiment provides the same advantageous effects as those provided by the machine learning device 100 according to the second embodiment. In addition, according to the fourth embodiment, since the hyperparameter vector can be changed, the hyperparameter vector can be optimized through machine learning. Thus, the prediction performance of the finally used model can be improved.

### Fifth Embodiment

Next, a fifth embodiment will be described. The fifth embodiment will be described with a focus on the difference from the second and fourth embodiments, and the description of the same features according to the fifth embodiment as those according to the second and fourth embodiments will be omitted as needed.

If machine learning is repeatedly performed by using many hyperparameter vectors per learning step, the overall execution time is prolonged. In addition, even when the same machine learning algorithm is executed, the execution time could change depending on the hyperparameter vector used. Thus, the user may wish to stop execution of a learning step that takes much time by setting a time limit. However, if a hyperparameter vector that needs more execution time is used, it is more likely that the obtained model indicates a higher prediction performance. Thus, if the same stopping time is set for machine learning per hyperparameter vector, there is a chance of missing out a model that indicates a high prediction performance.

Thus, in the fifth embodiment, a set of hyperparameter vectors is divided based on learning time levels (each of which indicates a period of time needed to completely learn a model). In addition, one machine learning algorithm that has used a hyperparameter vector having a learning time level and another machine learning algorithm that has used a hyperparameter vector having a different learning time level are treated as virtually different machine learning algorithms. Namely, a combination of a machine learning algorithm and a learning time level is treated as a virtual algorithm. In this way, even if the same machine learning algorithm is used, machine learning using a hyperparameter vector having a large learning time level is executed less preferentially (later). Namely, the next learning step of the same machine learning algorithm or a different machine learning algorithm is executed without waiting for completion of the machine learning having a large learning time level. However, while the machine learning using a hyperparameter vector having a large learning time level is executed less preferentially (later), there is a possibility that the machine learning is executed later. Thus, there is still a chance that the machine learning contributes to improvement in the prediction performance.

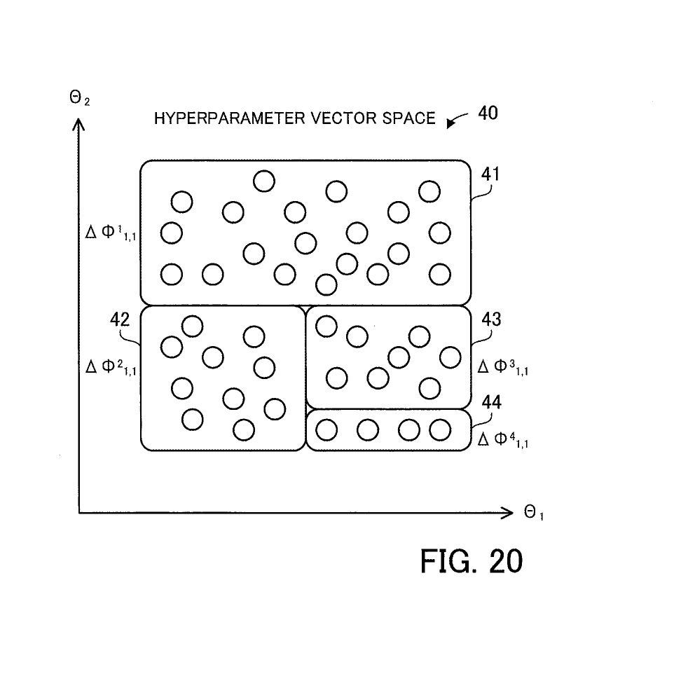

FIG. 20 illustrates an example of hyperparameter vector space.

The hyperparameter vector space is formed by a value of an individual one of one or more hyperparameters included in a hyperparameter vector. In the example in FIG. 20, a two-dimensional hyperparameter vector space 40 is formed by hyperparameters θ₁ and θ₂ included in an individual hyperparameter vector. In the example in FIG. 20, the hyperparameter vector space 40 is divided into regions 41 to 44.

A stopping time φ_{i,j}^{q} and a hyperparameter vector set ΔΦ_{i,j}^{q} are defined for a machine learning algorithm aᵢ, a sample size sⱼ, and a learning time level q. The larger the learning time level q is, the longer the stopping time φ_{i,j}^{q} will be. Hyperparameter vectors that belong to ΔΦ_{i,j}^{q} are those obtained when the machine learning algorithm aᵢ is executed by using training data having the sample size sⱼ and when the model learning is completed less than the stopping time φ_{i,j}^{q} (except those that belong to any of the learning time levels less than the learning time level q).

The regions 41 to 44 are examples obtained by dividing the hyperparameter vector space 40 when a machine learning algorithm a₁ is executed by using training data having the sample size s₁. The region 41 corresponds to a hyperparameter vector set ΔΦ_{1,1}¹, namely, a learning time level #1. For example, the hyperparameter vectors that belong to the region 41 are those used in model learning completed in less than 0.01 seconds. The region 42 corresponds to a hyperparameter vector set ΔΦ_{1,1}², namely, a learning time level #2. For example, the hyperparameter vectors that belong to the region 42 are those used in model learning completed with an execution time of 0.01 seconds or more and less than 0.1 seconds. The region 43 corresponds to a hyperparameter vector set ΔΦ_{1,1}³, namely, a learning time level #3. For example, the hyperparameter vectors that belong to the region 43 are those used in model learning completed with an execution time of 0.1 seconds or more and less than 1.0 second. The region 44 corresponds to a hyperparameter vector set ΔΦ_{1,1}⁴, namely, a learning time level #4. For example, the hyperparameter vectors that belong to the region 44 are those used in model learning completed with an execution time of 1.0 second or more and less than 10 seconds.

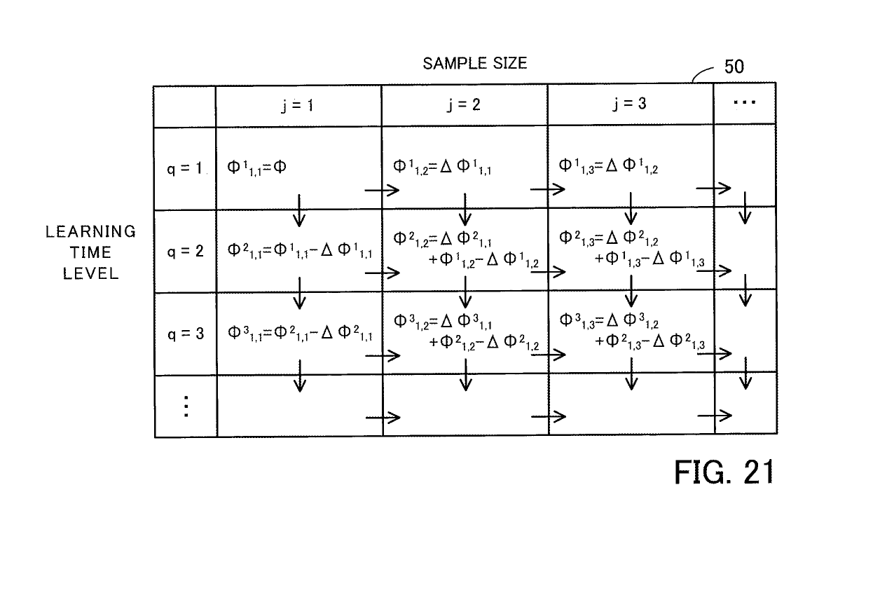

FIG. 21 is a first example of how a set of hyperparameter vectors is divided.

A table 50 indicates hyperparameter vectors used by the machine learning algorithm a₁ with respect to the sample size sⱼ and the learning time level q.

When the sample size is s₁ and the learning time level is #1, the hyperparameter vector set Φ_{1,1}¹ is used. This Φ_{1,1}¹ is the hyperparameter vector set extracted from the hyperparameter vector space 40 without any limitations on the regions. Among Φ_{1,1}¹, the hyperparameter vectors used in the model learning completed in less than the stopping time φ_{1,1}¹ belong to ΔΦ_{1,1}¹. When the sample size is s₁ and the learning time level is #2, the hyperparameter vector set Φ_{1,1}² is used. This Φ_{1,1}² is Φ_{1,1}¹−ΔΦ_{1,1}¹, namely, a set of hyperparameter vectors used in the model learning stopped when the sample size was s₁ and the learning time level was #1. Among Φ_{1,1}², those hyperparameter vectors used in the model learning completed in less than the stopping time φ_{1,1}² belong to ΔΦ_{1,1}¹. When the sample size is s₁ and the learning time level #3, the hyperparameter vector set Φ_{1,1}³ is used. This Φ_{1,1}³ is Φ_{1,1}²−ΔΦ_{1,1}², namely, a set of hyperparameter vectors used in the model learning stopped when the sample size was s₁ and the learning time level was #2.

When the sample size is s₂ and the learning time level is #1, a hyperparameter vector set Φ_{1,2}¹ is used. This Φ_{1,2}¹ is ΔΦ_{1,1}¹, namely, a set of hyperparameter vectors used in the model learning completed when the sample size was s₁ and the learning time level was #1. Among Φ_{1,2}¹, those hyperparameter vectors used in the model learning completed in less than a stopping time φ_{1,2}¹ belong to ΔΦ_{1,2}¹. When the sample size is s₂ and the learning time level is #2, a hyperparameter vector set Φ_{1,2}² is used. This Φ_{1,2}² includes Φ_{1,2}¹−ΔΦ_{1,2}¹, namely, those hyperparameter vectors used in the model learning stopped when the sample size was s₂ and the learning time level was #1. In addition, Φ_{1,2}² includes ΔΦ_{1,1}², namely, those hyperparameter vectors used in the model learning completed when the sample size was s₁ and the learning time level was #2. Among Φ_{1,2}², those hyperparameter vectors used in the model learning completed in less than the stopping time φ_{1,2}² belong to ΔΦ_{1,2}², When the sample size is s₂ and the learning time level is #3, a hyperparameter vector set Φ_{1,2}³ is used. This Φ_{1,2}³ includes Φ_{1,2}²−ΔΦ_{1,2}², namely, those hyperparameter vectors used in the model learning stopped when the sample size was s₂ and the learning time level was #2. In addition, Φ_{1,2}³ includes ΔΦ_{1,1}³, namely, those hyperparameter vectors used in the model learning completed when the sample size was s₁ and the learning time level was #3.

When the sample size is s₃ and the learning time level is #1, a hyperparameter vector set Φ_{1,3}¹ is used. This Φ_{1,3}¹ is ΔΦ_{1,2}¹, namely, a set of hyperparameter vectors used in the model learning completed when the sample size was s₂ and the learning time level was #1. Among Φ_{1,3}¹, those hyperparameter vectors used in the model learning completed in less than the stopping time φ_{1,3}¹ belong to ΔΦ_{1,3}¹. When the sample size is s₃ and the learning time level is #2, a hyperparameter vector set Φ_{1,3}² is used. This Φ_{1,3}² includes Φ_{1,3}¹−ΔΦ_{1,3}¹, namely, those hyperparameter vectors used in the model learning stopped when the sample size was s₃ and the learning time level was #1. In addition, Φ_{1,3}² includes ΔΦ_{1,2}², namely, those hyperparameter vector used in the model learning completed when the sample size was s₂ and the learning time level was #2. Among Φ_{1,3}², those hyperparameter vectors used in the model learning completed in less than the stopping time φ_{1,3}² belong to ΔΦ_{1,3}². When the sample size is s₃ and the learning time level is #3, a hyperparameter vector set Φ_{1,3}³ is used. This Φ_{1,3}³ includes Φ_{1,3}²−ΔΦ_{1,3}², namely, those hyperparameter vectors used in the model learning stopped when the sample size was s₃ and the learning time level was #2. In addition, Φ_{1,3}³ includes ΔΦ_{1,2}³, namely, those hyperparameter vectors used in the model learning completed when the sample size was s₂ and the learning time level was #3.

In this way, among the hyperparameter vectors used with the sample size sⱼ and the learning time level q, the hyperparameter vectors used in the model learning completed in less than the stopping time φ_{1,j}^{q} are passed to the model learning executed with the sample size sⱼ₊₁ and the learning time level q. In contrast, among the hyperparameter vectors used with the sample size sⱼ and the learning time level q, the hyperparameter vectors used in the model learning stopped are passed to the model learning executed with the sample size sⱼ and the learning time level q+1.

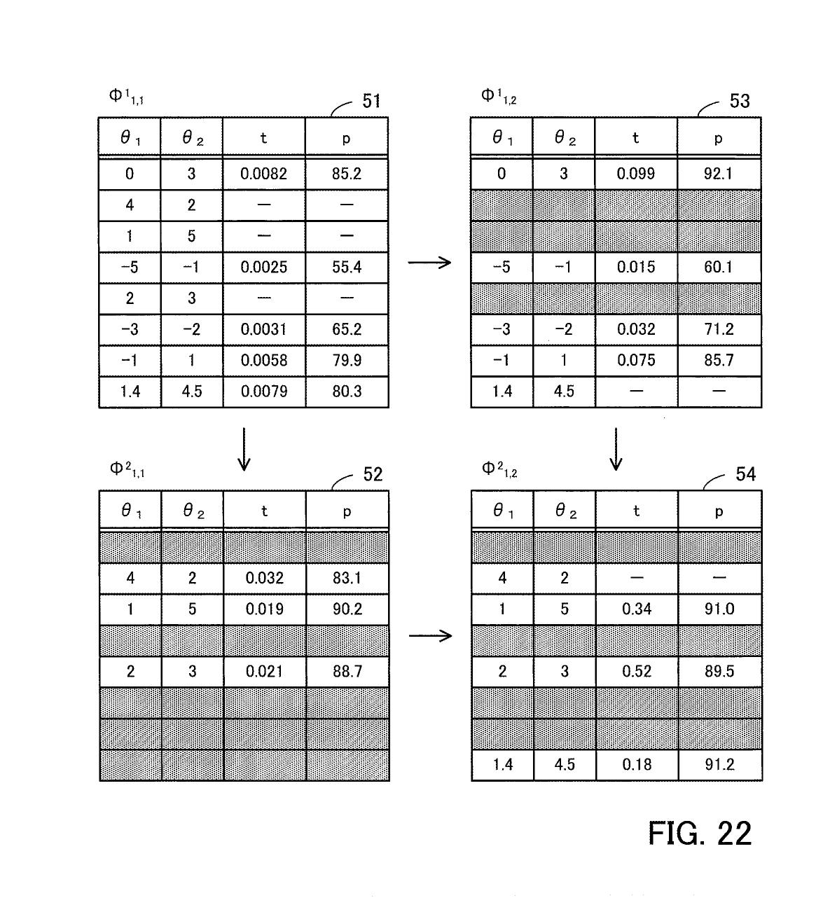

FIG. 22 is a second example of how a set of hyperparameter vectors is divided.

A table 51 indicates examples of hyperparameter vectors (θ₁,θ₂) that belong to Φ_{1,1}¹ and their execution results, each of which includes the execution time t and the prediction performance p. A table 52 indicates examples of hyperparameter vectors (θ₁,θ₂) that belong to Φ_{1,1}² and their execution results. A table 53 indicates examples of hyperparameter vectors (θ₁,θ₂) that belong to Φ_{1,2}¹ and their execution results. A table 54 indicates examples of hyperparameter vectors (θ₁,θ₂) that belong to Φ_{1,2}² and their execution results.

The table 51 (Φ_{1,1}¹) includes (0,3), (4,2), (1,5), (−5,−1), (2,3), (−3,−2), (−1,1) and (1.4,4.5) as the hyperparameter vectors. When the sample size is s₁ and the learning time level is #1, the model learning with (0,3), (−5,−1), (−3,−2), (−1,1), and (1.4,4.5) is completed within the corresponding stopping time, and the model learning with (4,2), (1,5), and (2,3) is stopped before its completion. Thus, these hyperparameter vectors (4,2), (1,5), and (2,3) are passed to Φ_{1,1}². In contrast, (0,3), (−5,−1), (−3,−2), (−1,1), and (1.4,4.5) are passed to Φ_{1,2}¹.

As illustrated in the table 52, when the sample size is s₁ and the learning time level is #2, all the model learning with (4,2), (1,5), and (2,3) is completed within the corresponding stopping time. Thus, these hyperparameter vectors (4,2), (1,5), and (2,3) are passed to Φ_{1,2}². In addition, as illustrated in the table 53, when the sample size is s₂ and the learning time level is #1, the model learning with (0,3), (−5,−1), (−3,−2), and (−1,1) are completed within the corresponding stopping time, and the model learning with (1.4,4.5) is stopped before its completion. Thus, the hyperparameter vector (1.4,4.5) is passed to Φ_{1,2}².

As illustrated in the table 54, when the sample size is s₂ and the learning time level is #2, (4,2), (1,5), (2,3), and (1.4,4.5) are used. The model learning with (1,5), (2,3), and (1.4,4.5) is completed within the corresponding stopping time, and the model learning with (4,2) is stopped before its completion.

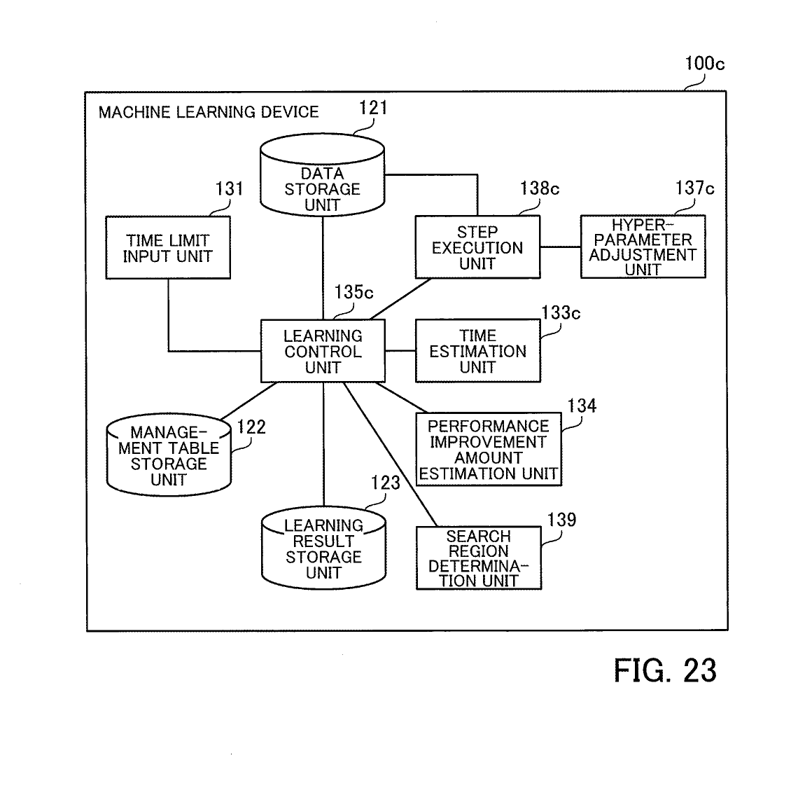

FIG. 23 is a block diagram illustrating an example of functions of a machine learning device 100c according to a fifth embodiment.

The machine learning device 100c includes a data storage unit 121, a management table storage unit 122, a learning result storage unit 123, a time limit input unit 131, a time estimation unit 133c, a performance improvement amount estimation unit 134, a learning control unit 135c, a hyperparameter adjustment unit 137c, a step execution unit 138c, and a search region determination unit 139. The search region determination unit 139 may be realized by using a program module executed by the CPU, for example. The machine learning device 100c may be realized by using the same hardware as that of the machine learning device 100 according to the second embodiment illustrated in FIG. 2.

The search region determination unit 139 determines a set of hyperparameter vectors (a search region) used in the next learning step in response to a request from the learning control unit 135c. The search region determination unit 139 receives a specified machine learning algorithm aᵢ, sample size sⱼ, and learning time level q from the learning control unit 135c. The search region determination unit 139 determines Φ_{i,j}^{q} as described above. Namely, among the hyperparameter vectors included in Φ_{i,j-1}^{q}, the search region determination unit 139 adds the hyperparameter vectors used in the model learning completed to Φ_{i,j}^{q}. In addition, if the model learning has already been executed with the sample size sⱼ and the learning time level q−1, among the hyperparameter vectors included in Φ_{i,j}^{q-1}, the search region determination unit 139 adds the hyperparameter vectors used in the model learning stopped to Φ_{i,j}^{q}.

However, when j=1 and q=1, the search region determination unit 139 selects hyperparameter vectors as many as possible from the hyperparameter vector space through random search, grid search, or the like and adds the selected hyperparameter vectors to Φ_{1,1}¹.

The management table storage unit 122 holds the management table 122a illustrated in FIG. 9. In the fifth embodiment, a combination of a machine learning algorithm and a learning time level is treated as a virtual algorithm. Thus, in the management table 122a, a record is registered for each combination of a machine learning algorithm and a learning time level.

As in the second embodiment, in response to a request from the learning control unit 135c, the time estimation unit 133c estimates the execution time of the next learning step (the next sample size) per machine learning algorithm and per learning time level. In addition, the time estimation unit 133c estimates the stopping time of the next sample size per machine learning algorithm and per learning time level. In the case of the machine learning algorithm aᵢ, the sample size sⱼ₊₁, and the learning time level q, the stopping time can be calculated by φ_{i,j+1}^{q}=γ×φ_{i,j}^{q}, for example.

The coefficient γ in the expression can be determined by the same method (a regression analysis, etc.) as the coefficient α in the expression for estimating the execution time described in the second embodiment is determined. When a hyperparameter vector that shortens the execution time is used, the obtained model tends to indicate a low prediction performance. When a hyperparameter vector that prolongs the execution time is used, the obtained model tends to indicate a high prediction performance. Thus, when model learning is completed, if the execution time obtained by using the corresponding hyperparameter vector is directly used for a regression analysis, the stopping time could be set too small, and a model that indicates a low prediction performance could be generated easily. Thus, for example, among the hyperparameter vectors used in the model learning completed, the time estimation unit 133c may extract the hyperparameter vectors with above-average prediction performances and use the execution times obtained by using them for a regression analysis. Alternatively, the time estimation unit 133c may use a maximal value, an average value, a median value, etc. of the execution times extracted for a regression analysis.

The learning control unit 135c defines a combination of the machine learning algorithm aᵢ and the learning time level q as a virtual algorithm a^{q}ᵢ. The learning control unit 135c selects the virtual algorithm that corresponds to the learning step executed next and the corresponding sample size in the same way as in the second embodiment. In addition, the learning control unit 135c determines the stopping times φ_{i,1}¹, q_{i,1}², . . . , φ_{i,1}^{Q} for the sample size s₁ of the machine learning algorithm aᵢ. The maximum learning time level is denoted by Q. For example, Q=5. These stopping times may be shared among a plurality of machine learning algorithms. For example, θ_{i,1}¹=0.01 seconds, φ_{i,1}²=0.1 seconds, φ_{i,1}³=1 second, φ_{i,1}⁴=10 seconds, and φ_{i,1}⁵=100 seconds. The stopping times after the sample size s₂ are calculated by the time estimation unit 133c. The learning control unit 135c specifies the machine learning algorithm aᵢ, the sample size sⱼ, the search region (Φ_{i,j}^{q}) determined by the search region determination unit 139, and the stopping time φ_{i,j}^{q} to the step execution unit 138c.

In response to a request from the step execution unit 138c, the hyperparameter adjustment unit 137c selects hyperparameter vectors included in the search region specified by the learning control unit 135c or hyperparameter vectors near the search region.

The step execution unit 138c executes learning steps one by one in the same way as in the fourth embodiment. However, if stopping time φ_{i,j}^{q} has elapsed since the start of machine learning using a hyperparameter vector, the step execution unit 138c stops the machine learning without waiting for the completion of the machine learning. In this case, a model that corresponds to the hyperparameter vector is not generated. In addition, the prediction performance that corresponds to the hyperparameter vector is deemed to be the minimum possible value of the prediction performance index value. For example, when the sample size is other than s₁, the number of hyperparameter vectors used in a single learning step (threshold H) is 30. When the sample size is s₁, H=Max (10000/10^{q-1}, 30), for example.

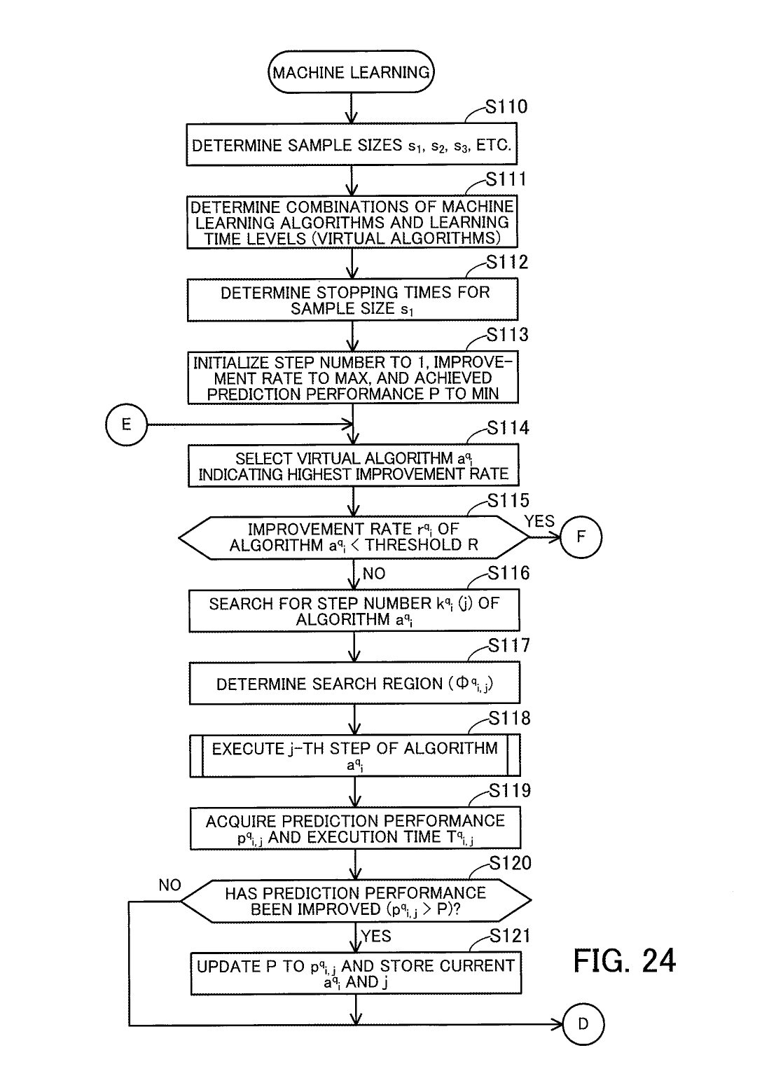

FIG. 24 is a flowchart illustrating an example of a procedure of machine learning according to the fifth embodiment.

(S110) The learning control unit 135c determines the samples sizes s₁, s₂, s₃, . . . of the learning steps used in progressive sampling.

(S111) The learning control unit 135c determines the maximal learning time level Q (for example, Q=5). Next, the learning control unit 135c determines combinations of usable machine learning algorithms and learning time levels to be virtual algorithms.

(S112) The learning control unit 135c determines the stopping times of an individual virtual algorithm for the sample size s₁. For example, the same values are used for all the machine learning algorithms. For example, 0.01 seconds is set for the learning time level #1, 0.1 seconds for the learning time level #2, 1 second for the learning time level #3, 10 seconds for the learning time level #4, and 100 seconds for the learning time level #5.

(S113) The learning control unit 135c initializes the step number of an individual virtual algorithm to 1. In addition, the learning control unit 135c initializes the improvement rate of an individual virtual algorithm to its maximum possible improvement rate. In addition, the learning control unit 135c initializes the achieved prediction performance P to its minimum possible prediction performance P (for example, 0).

(S114) The learning control unit 135c selects a virtual algorithm that indicates the highest improvement rate from the management table 122a. The selected virtual algorithm will be denoted as a^{q}ᵢ.

(S115) The learning control unit 135c determines whether the improvement rate r^{q}ᵢ of the virtual algorithm a^{q}ᵢ is less than a threshold R. For example, the threshold R=0.001/3600 [seconds⁻¹]. If the improvement rate r^{q}ᵢₒ is less than the threshold R, the operation proceeds to step S132. Otherwise, the operation proceeds to step S116.

(S116) The learning control unit 135c searches the management table 122a for a step number k^{q}ᵢ of the virtual algorithm a^{q}ᵢ. This example assumes that k^{q}ᵢ=j.

(S117) The search region determination unit 139 determines a search region that corresponds to the virtual algorithm a^{q}ᵢ (the machine learning algorithm aᵢ and the learning time level q) and the sample size sⱼ. Namely, the search region determination unit 139 determines the hyperparameter vector set Φ_{i,j}^{q} in accordance with the above method.

(S118) The step execution unit 138c executes the j-th learning step of the virtual algorithm a^{q}ᵢ. Namely, the hyperparameter adjustment unit 137c selects a hyperparameter vector included in the search region determined in step S117 or a hyperparameter vector near the hyperparameter vector. The step execution unit 138c applies the selected hyperparameter vector to the machine learning algorithm aᵢ and learns a model by using training data having the sample size sⱼ. However, if the stopping time φ_{i,j}^{q}, elapses after the start of the model learning, the step execution unit 138c stops the model learning using the hyperparameter vector. The step execution unit 138c repeats the above processing for a plurality of hyperparameter vectors. The step execution unit 138c determines a model, the prediction performance p^{q}_{i,j}, and the execution time T^{q}_{i,j} from the results of the learning not stopped.

(S119) The learning control unit 135c acquires the learned model, the prediction performance p^{q}_{i,j} thereof, the execution time T^{q}_{i,j} from the step execution unit 138c.

(S120) The learning control unit 135c compares the prediction performance p^{q}_{i,j} acquired in step S119 with the achieved prediction performance P (the maximum prediction performance achieved up until now) and determines whether the former is larger than the latter. If the prediction performance p^{q}_{i,j} is larger than the achieved prediction performance P, the operation proceeds to step S121. Otherwise, the operation proceeds to step S122.

(S121) The learning control unit 135c updates the achieved prediction performance P to the prediction performance p^{q}_{i,j}. In addition, the learning control unit 135c associates the achieved prediction performance P with the corresponding virtual algorithm a^{q}ᵢ and step number j and stores the associated information.

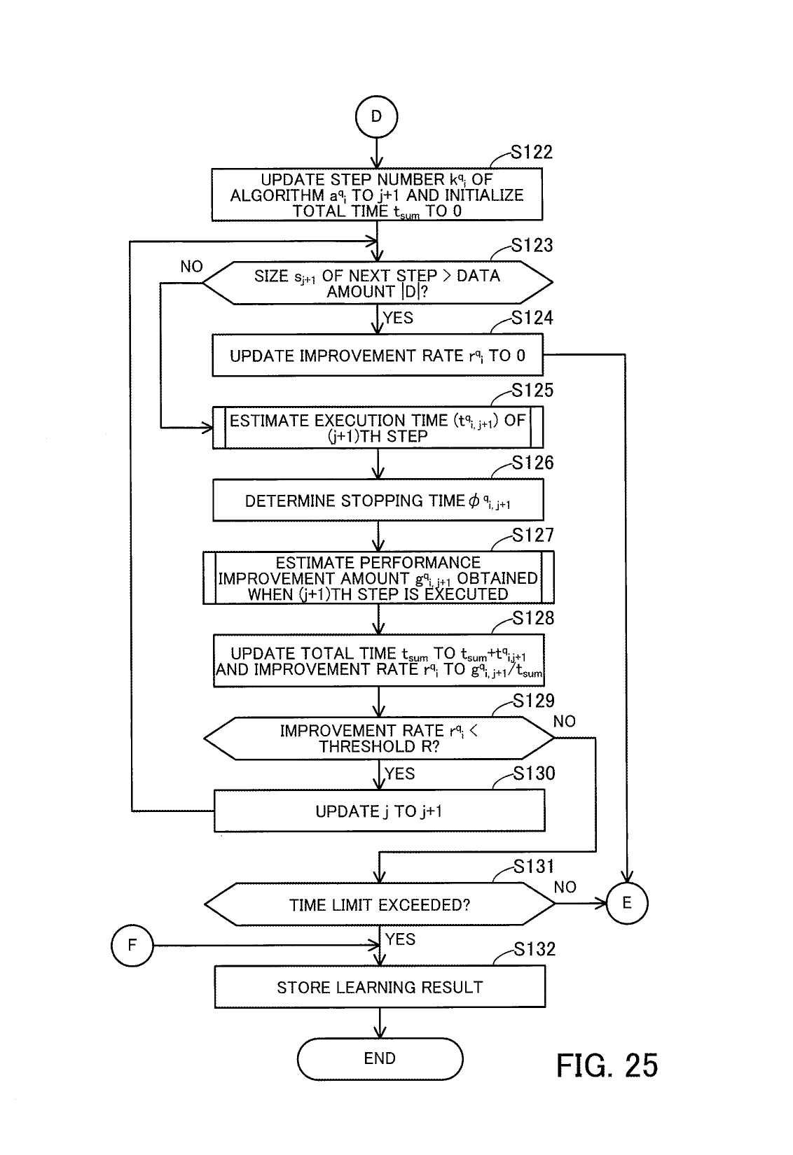

FIG. 25 is a diagram that follows FIG. 24.

(S122) Among the step numbers stored in the management table 122a, the learning control unit 135c updates the step number k^{q}ᵢ that corresponds to the virtual algorithm a^{q}ᵢ to j+1. In addition, the learning control unit 135c initializes the total time tₛᵤₘ to 0.

(S123) The learning control unit 135c calculates the sample size sⱼ₋₁ of the next learning step of the virtual algorithm a^{q}ᵢ. The learning control unit 135c compares the sample size sⱼ₊₁ with the size of the data set D stored in the data storage unit 121 and determines whether the former is larger than the latter. If the sample size sⱼ₊₁ is larger than the size of the data set D, the operation proceeds to step S124. Otherwise, the operation proceeds to step S125.

(S124) Among the improvement rates stored in the management table 122a, the learning control unit 135c updates the improvement rate r^{q}ᵢ that corresponds to the virtual algorithm a^{q}ᵢ to 0. Next, the operation returns to the above step S114.

(S125) The learning control unit 135c specifies the virtual algorithm a^{q}ᵢ and the step number j+1 to the time estimation unit 133c. The time estimation unit 133c estimates an execution time t^{q}_{i,j+1} needed when the next learning step (the (j+1)th learning step) of the virtual algorithm a^{q}ᵢ is executed.

(S126) The learning control unit 135c determines stopping time φ_{i,j+1}^{q} of the next learning step (the (j+1)th learning step) of the virtual algorithm a^{q}ᵢ.

(S127) The learning control unit 135c specifies the virtual algorithm a^{q}ᵢ and the step number j+1 to the performance improvement amount estimation unit 134. The performance improvement amount estimation unit 134 estimates a performance improvement amount g^{q}_{i,j+1} obtained when the next learning step (the (j+1)th learning step) of the virtual algorithm a^{q}ᵢ is executed.

(S128) The learning control unit 135c updates the total time tₛᵤₘ to tₛᵤₘ+t^{q}_{i,j+1}, on the basis of the execution time t^{q}_{i,j+1} obtained from the time estimation unit 133c. In addition, the learning control unit 135c calculates the improvement rate r^{q}ᵢ=g^{q}_{i,j+1}/tₛᵤₘ, on the basis of the updated total time tₛᵤₘ and the performance improvement amount g^{q}_{i,j+1} acquired from the performance improvement amount estimation unit 134. The learning control unit 135c updates the improvement rate r^{q}ᵢ stored in the management table 122a to the above value.

(S129) The learning control unit 135c determines whether the improvement rate r^{q}ᵢ is less than the threshold R. If the improvement rate r^{q}ᵢ is less than the threshold R, the operation proceeds to step S130. If the improvement rate r^{q}ᵢ is equal to or more than the threshold R, the operation proceeds to step S131.

(S130) The learning control unit 135c updates j to j+1. Next, the operation returns to step S123.

(S131) The learning control unit 135c determines whether the time that has elapsed since the start of the machine learning has exceeded a time limit specified by the time limit input unit 131. If the elapsed time has exceeded the time limit, the operation proceeds to step S132. Otherwise, the operation returns to step S114.

(S132) The learning control unit 135c stores the achieved prediction performance P and the model that indicates the prediction performance in the learning result storage unit 123. In addition, the learning control unit 135c stores the algorithm ID of the machine learning algorithm associated with the achieved prediction performance P and the sample size that corresponds to the step number associated with the achieved prediction performance P in the learning result storage unit 123. In addition, the learning control unit 135c stores the hyperparameter vector θ used to learn the model in the learning result storage unit 123.

The machine learning device 100c according to the fifth embodiment provides the same advantageous effects as those provided by the second and fourth embodiments. In addition, according to the fifth embodiment, if a hyperparameter vector corresponds to a large learning time level, the machine learning is stopped before its completion and is executed less preferentially (later) Namely, the machine learning device 100c is able to proceed with the next learning step of the same or a different machine learning algorithm without waiting for the completion of the machine learning with all the hyperparameter vectors. Thus, the execution time per learning step is shortened. In addition, the machine learning using those hyperparameter vectors that correspond to large learning time levels could still be executed later. Thus, it is possible to reduce the risk of missing out hyperparameter vectors that contribute to improvement in the prediction performance.

As described above, the information processing according to the first embodiment may be realized by causing the machine learning management device 10 to execute a program. The information processing according to the second embodiment may be realized by causing the machine learning device 100 to execute a program. The information processing according to the third embodiment may be realized by causing the machine learning device 100a to execute a program. The information processing according to the fourth embodiment may be realized by causing the machine learning device 100b to execute a program. The information processing according to the fifth embodiment may be realized by causing the machine learning device 100c to execute a program.

An individual program may be recorded in a computer-readable recording medium (for example, the recording medium 113). Examples of the recording medium include a magnetic disk, an optical disc, a magneto-optical disk, and a semiconductor memory. Examples of the magnetic disk include an FD and an HDD. Examples of the optical disc include a CD, a CD-R (Recordable)/RW (Rewritable), a DVD, and a DVD-R/RW. An individual program may be recorded in a portable recording medium and then distributed. In this case, an individual program may be copied from the portable recording medium to a different recording medium (for example, the HDD 103) and the copied program may be executed.

According to one aspect, the prediction performance of a model obtained by machine learning is efficiently improved.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable recording medium storing a computer program that causes a computer to perform a procedure comprising:
executing each of a plurality of machine learning algorithms by using training data;
calculating, based on execution results of the plurality of machine learning algorithms, increase rates of prediction performances of a plurality of models generated by the plurality of machine learning algorithms, respectively; and
selecting, based on the increase rates, one of the plurality of machine learning algorithms and executing the selected machine learning algorithm by using other training data.

2. The non-transitory computer-readable recording medium according to claim 1,
wherein said other training data has a size larger than a size of the training data.

3. The non-transitory computer-readable recording medium according to claim 1,
wherein the procedure further includes:
updating, based on an execution result of the selected machine learning algorithm, an increase rate of a prediction performance of a model generated by the selected machine learning algorithm; and
selecting, based on the updated increase rate, a machine learning algorithm that is executed next from the plurality of machine learning algorithms.

4. The non-transitory computer-readable recording medium according to claim 1,
wherein increase amounts of prediction performances and execution times of the plurality of machine learning algorithms obtained when the size of the training data is increased are calculated, respectively, and
wherein the increase rates are calculated based on the increase amounts of the prediction performances and the execution times, respectively.

5. The non-transitory computer-readable recording medium according to claim 4,
wherein, each of the increase rates of the prediction performances is a value larger than an estimated value calculated by performing statistical processing on the execution result of the corresponding machine learning algorithm by a predetermined amount or an amount that indicates a statistical error.

6. The non-transitory computer-readable recording medium according to claim 4,
wherein each of the execution times is calculated by using a different mathematical expression per machine learning algorithm.

7. The non-transitory computer-readable recording medium according to claim 1,
wherein, when each of the plurality of machine learning algorithms is executed, at least two models are generated by using a plurality of parameters applicable to the corresponding machine learning algorithm, and
wherein the larger one of the prediction performances of the generated models is determined as the execution result of the machine learning algorithm.

8. The non-transitory computer-readable recording medium according to claim 7,
wherein, when each of the plurality of machine learning algorithms is executed and when elapsed time exceeds a threshold regarding a parameter, generation of a model using the parameter is stopped, and
wherein, when one of the machine learning algorithms is selected, the selection is made based on the increase rates and the selected machine learning algorithm is executed by using said other training data or the execution is performed again by increasing the threshold and using the parameter.

9. A machine learning management apparatus comprising:
a memory configured to hold data used for machine learning; and
a processor configured to perform a procedure including:
executing each of a plurality of machine learning algorithms by using training data included in the data;
calculating, based on execution results of the plurality of machine learning algorithms, increase rates of prediction performances of a plurality of models generated by the plurality of machine learning algorithms, respectively; and
selecting, based on the increase rates, one of the plurality of machine learning algorithms and executing the selected machine learning algorithm by using other training data included in the data.

10. A machine learning management method comprising:
executing, by a processor, each of a plurality of machine learning algorithms by using training data;
calculating, by the processor, based on execution results of the plurality of machine learning algorithms, increase rates of prediction performances of a plurality of models generated by the plurality of machine learning algorithms, respectively; and
selecting, by the processor, based on the increase rates, one of the plurality of machine learning algorithms and executing the selected machine learning algorithm by using other training data.
